(19) United States
(12) Patent Application Publication
(10) Pub. No.: US 2024/0080263 A1
(43) Pub. Date: Mar. 7, 2024

(54) PACKET PROCESSING APPARATUS AND COMMUNICATION SYSTEM

(71) Applicant: Fujitsu Limited, Kawasaki-shi (JP)

(72) Inventors: Yu TAJIMA, Kawasaki (JP); Ryohei YAGINIWA, Kawasaki (JP); Takashi FUKAGAWA, Yokohama (JP)

(73) Assignee: Fujitsu Limited, Kawasaki-shi (JP)

(21) Appl. No.: 18/211,800

(22) Filed: Jun. 20, 2023

(30) Foreign Application Priority Data
Sep. 5, 2022 (JP) 2022-140952

(51) Int. Cl. H04L 45/302; H04W 40/02

(52) U.S. Cl. CPC H04L 45/304; H04W 40/02

(57) ABSTRACT

A packet processing apparatus includes a memory configured to store, for each time slot number, switching information for switching output of a packet of each packet type, a counter configured to count the time slot number, an output control circuit configured to control the output, based on the switching information that corresponds to the time slot number currently counted, a transmitter configured to transmit a control packet for resetting the time slot number currently counted in each packet processing apparatus in a set path, in a predetermined direction of the set path in accordance with a predetermined timing, and a reset circuit configured to, in response to a start of a transmission of the control packet, reset the time slot number currently counted and restart a count operation of the counter.

### CROSS-REFERENCE TO RELATED APPLICATION

This application is based upon and claims the benefit of priority of the prior Japanese Patent Application No. 2022-140952, filed on Sep. 5, 2022, the entire contents of which are incorporated herein by reference.

### FIELD

The embodiments discussed herein are related to a packet processing apparatus and a communication system.

### BACKGROUND

In recent years, for example, in a communication system coupled to a mobile fronthaul (MFH) link, information is handled as layer 2 packets, and thus the network may be shared with a mobile backhaul (MBH) link that couples base stations to each other, a wired network, or the like. However, in the communication system, an output delay occurs because of a timing conflict between an MFH packet from the MFH link and another packet, for example, an MBH packet from the MBH link. Accordingly, a priority control process is known as a technique for suppressing the output delay in the communication system. In the priority control process, a subsequent high-priority packet is preferentially read before a queued low-priority packet. Thus, the output delay of the high-priority packet, for example, the MFH packet may be suppressed.

Institute of Electrical and Electronics Engineers (IEEE) 802.1 Time Sensitive Networking (TSN) is studied as another method for suppressing the output delay. The TSN includes a Time Aware Shaper (TAS) method called the IEEE 802.1Qbv as a data plane function to suppress the output delay of the packet.

A TAS apparatus which is a packet processing apparatus that adopts a TAS technique performs switching of each gate, based on a gate control list (GCL) for controlling switching of each gate provided for a corresponding type of a received packet. The gate is, for example, a gate that performs switching of output of an MFH packet, or, for example, a gate that performs switching of output of an MBH packet. The GCL manages switching information for controlling switching of each gate for each time slot (TS) by using a traffic pattern of MFH packets. By controlling switching of each gate for each TS with reference to the GCL, the TAS apparatus may preferentially output the MFH packets.

To implement a very sensitive gate switching setting in an order of microseconds, a mechanism for maintaining the very sensitive gate switching setting is desired in the TAS apparatus. Accordingly, the TAS apparatus acquires timings of MFH packets and MBH packets, and performs autonomous training based on the transfer period, phase, and the like of these packets. The TAS apparatus adopts an intelligent TAS (iTAS) technique for correcting a table content of the GCL that manages output timings of the MFH packets or the MFH packets, based on the content of the autonomous training.

Japanese Laid-open Patent Publication No. 2017-63363, Japanese National Publication of International Patent Application No. 2008-518552, and Japanese Laid-open Patent Publication No. 2001-358766 are disclosed as related art.

### SUMMARY

According to an aspect of the embodiments, a packet processing apparatus includes a memory configured to store, for each time slot number, switching information for switching output of a packet of each packet type, a counter configured to count the time slot number, an output control circuit configured to control the output, based on the switching information that corresponds to the time slot number currently counted, a transmitter configured to transmit a control packet for resetting the time slot number currently counted in each packet processing apparatus in a set path, in a predetermined direction of the set path in accordance with a predetermined timing, and a reset circuit configured to, in response to a start of a transmission of the control packet, reset the time slot number currently counted and restart a count operation of the counter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a communication system;

FIG. 2 is an explanatory diagram illustrating an example of a configuration of an iTAS apparatus;

FIG. 3 is an explanatory diagram illustrating an example of a GCL;

FIG. 4 is an explanatory diagram illustrating an example of a transfer rule;

FIG. 5 is an explanatory diagram illustrating an example of a format of a time packet;

FIG. 6 is an explanatory diagram illustrating an example of a configuration of a control apparatus;

FIG. 7 is an explanatory diagram illustrating an example of a communication system at the time of path setting;

FIG. 8 is a sequence diagram illustrating an example of a processing operation of the iTAS apparatus in each node related to a first TS synchronization process;

FIG. 9 is an explanatory diagram illustrating an example of the communication system in a state in which a second set path is added to a first set path;

FIG. 10 is a sequence diagram illustrating an example of a processing operation of the iTAS apparatus in each node in the second set path related to a second TS synchronization process;

FIG. 11 is an explanatory diagram illustrating an example of a TS difference that occurs in a terminal node;

FIG. 12 is an explanatory diagram illustrating an example of TS ranges of a first high-priority packet and a second high-priority packet in each node illustrated in FIG. 9;

FIG. 13 is an explanatory diagram illustrating an example of a communication system in a state in which a third set path is added to the first set path;

FIG. 14 is a sequence diagram illustrating an example of a processing operation in each node in the third set path related to a third TS synchronization process;

FIG. 15 is an explanatory diagram illustrating an example of a TS difference that occurs in a merging node;

FIG. 16 is an explanatory diagram illustrating an example of TS ranges of the first high-priority packet and the second high-priority packet in each node illustrated in FIG. 13;

FIG. 17 is a schematic diagram of the communication system in a state in which the first set path is set;

FIG. 18 is a flowchart illustrating an example of a processing operation of the control apparatus related to a control-apparatus-side TS synchronization process;

FIG. 19 is a flowchart illustrating an example of a processing operation of an edge node related to an edge-node-side TS synchronization process;

FIG. 20 is a flowchart illustrating an example of a processing operation of an intermediate node related to an intermediate-node-side TS synchronization process;

FIG. 21 is a flowchart illustrating an example of the processing operation of the intermediate node related to the intermediate-node-side TS synchronization process;

FIG. 22 is a flowchart illustrating an example of a processing operation of a terminal node related to a terminal-node-side TS synchronization process;

FIG. 23 is a schematic diagram of the communication system in a state in which a fourth set path is added to the first set path;

FIG. 24 is a flowchart illustrating an example of a processing operation of the merging node related to a merging-node-side TS synchronization process;

FIG. 25 is a schematic diagram of the communication system in a state in which a fifth set path is added the first set path;

FIG. 26 is a flowchart illustrating an example of a processing operation of the merging node related to the merging-node-side TS synchronization process;

FIG. 27 is an explanatory diagram illustrating an example of an issue of TS congestion; and

FIG. 28 is an explanatory diagram illustrating an example of an issue of a transmission delay.

### DESCRIPTION OF EMBODIMENTS

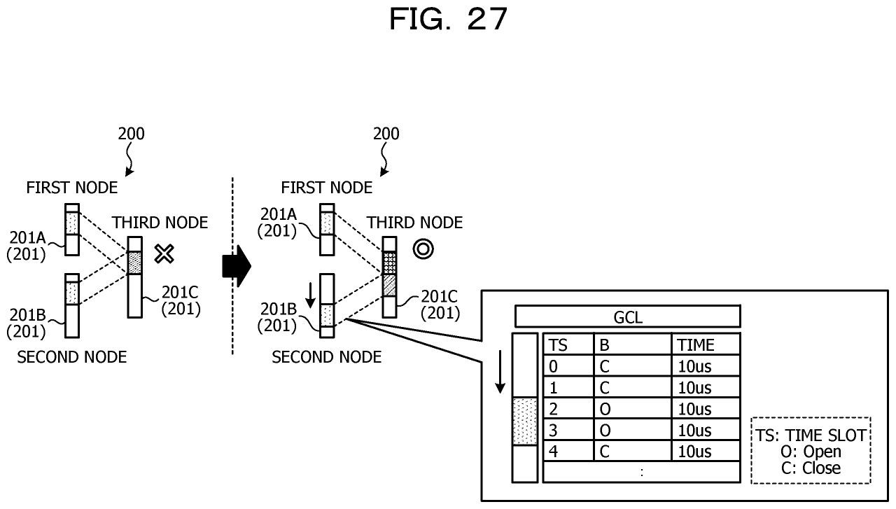

FIG. 27 is an explanatory diagram illustrating an example of an issue of TS congestion. A communication system 200 illustrated in FIG. 27 includes, for example, a first node 201A (201), a second node 201B (201), and a third node 201C (201). It is assumed that in each of the nodes 201, an iTAS apparatus is built in for each input/output port. The third node 201C is a merging node that receives high-priority packets from the first node 201A and the second node 201B. When the iTAS apparatus in the third node 201C simultaneously receives a high-priority packet from the iTAS apparatus in the first node 201A and a high-priority packet from the iTAS apparatus in the second node 201B, TAS reserved bands overlap and consequently TS congestion of the high-priority packets occurs. In this case, the iTAS apparatus in the third node 201C corrects the content of the GCL to delay an output timing of the high-priority packet from the iTAS apparatus in the second node 201B. The iTAS apparatus in the second node 201B also corrects the content of the GCL to reflect the corrected content of the GCL of the iTAS apparatus in the third node 201C. For example, a control apparatus that monitors and controls each of the nodes 201 in the communication system 200 is to adjust the content of the individual GCLs in a state in which a band at the output timing of the high-priority packet in the communication system 200 is assured.

However, in the communication system 200, when TSs used by the individual iTAS apparatuses in the respective nodes 201 are asynchronous, it is difficult for the control apparatus that monitors each of the nodes 201 to adjust the content of the individual GCLs in the state in which the band at the output timing of the high-priority packet in the communication system 200 is assured. Accordingly, it is desired to synchronize the TS timings between the iTAS apparatuses in the respective nodes 201 in the communication system 200.

### COMPARATIVE EXAMPLE

For example, in recent years, Deterministic Networking (DetNet) has been known as an assured-type service that has a markedly low packet loss rate and is capable of providing an end-to-end transmission delay upper limit. An edge node in the DetNet may provide artificial periodicity by causing out-of-order packets to stay/rectifying out-of-order packets. Accordingly, adoption of an iTAS apparatus in the edge node in the DetNet is also conceivable.

However, if transmission timings of packets sent out with the artificial period are set in the edge node in the DetNet in an unplanned manner, congestion occurs in an intermediate node, in a communication system, that receives a plurality of high-priority packets. Thus, a band of a logical path may not be assured. Accordingly, a control apparatus that monitors and controls each of nodes in the communication system coupled to a DetNet is to synchronize TS timings between iTAS apparatuses in the respective nodes in the communication system. However, clocks that generate TSs have a frequency deviation of about ±5 microseconds per second, for example. TSs used by the individual iTAS apparatuses in the respective nodes in the communication system are asynchronous.

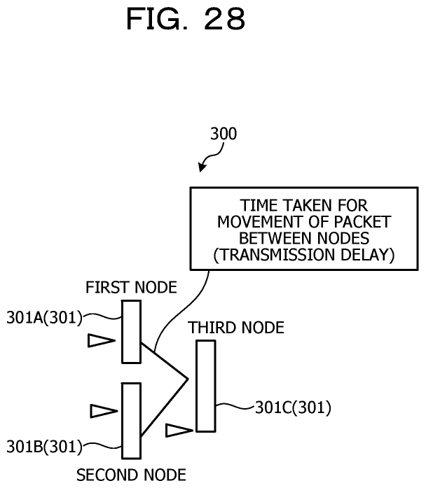

FIG. 28 is an explanatory diagram illustrating an example of an issue of a transmission delay. A communication system 300 illustrated in FIG. 28 includes a first node 301A (301), a second node 301B (301), and a third node 301C (301). It is assumed that in each of the nodes 301, an iTAS apparatus is built in for each input/output port. The third node 301C is a merging node that receives high-priority packets from the first node 301A and the second node 301B.

Because TSs used by the iTAS apparatuses in the respective nodes 301 in the communication system 300 are asynchronous, certain specific timing points, for example, TS numbers currently counted differ between the iTAS apparatuses. A control apparatus that monitors each of the nodes 301 has difficulty in grasping the TS numbers counted by the individual iTAS apparatuses in the respective nodes 301. A packet transmission delay occurs in a path between the individual iTAS apparatuses in the respective nodes 301. However, the control apparatus has difficulty in grasping an amount of this transmission delay. Accordingly, the control apparatus has difficulty in designating the TS number of an operation target in the GCL of each of the iTAS apparatuses. Because the TS numbers counted and used by the iTAS apparatuses in the respective nodes 301 are asynchronous, congestion of high-priority packets occurs in the communication system 300. This point becomes appreciable in a communication system coupled to a DetNet.

Accordingly, a packet processing apparatus or the like is desired that may avoid congestion of high-priority packets by synchronizing TS timings, for example, synchronizing TS numbers between iTAS apparatuses in respective nodes in a set path while taking into account a packet transmission delay between the iTAS apparatuses. Thus, embodiments of techniques capable of synchronizing timings of TSs between iTAS apparatuses (packet processing apparatuses) in respective nodes in a set path will be described below. The issues and embodiments in this specification are merely an example and not intended to limit the scope of the right of the present application. For example, even if technically equivalent components or configurations are described with different expressions, the techniques of the present application are applicable even to the components or configurations described with the different expressions and the different expressions are not intended to limit the scope of right. The individual embodiments may be appropriately combined within a range not causing any contradiction in processing content.

### EMBODIMENTS

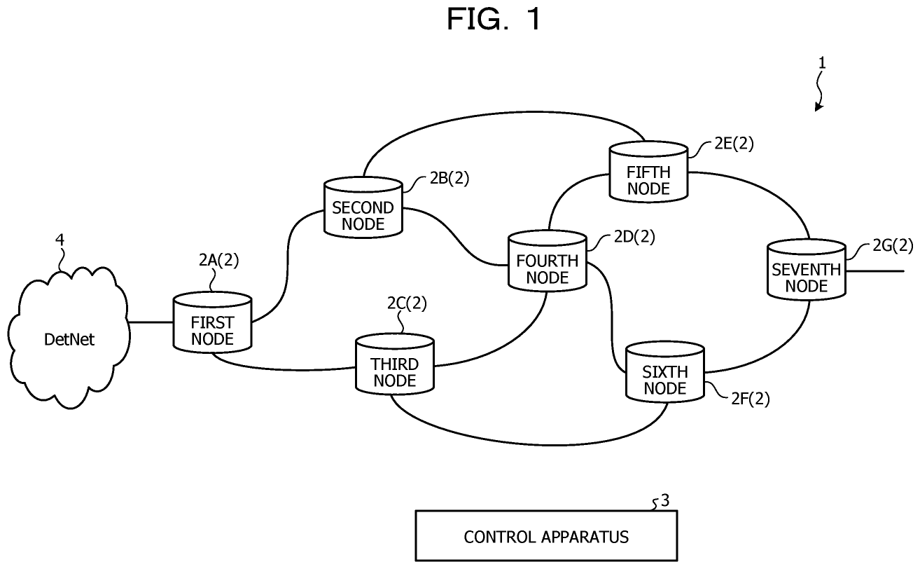

FIG. 1 is an explanatory diagram illustrating an example of a communication system 1. The communication system 1 illustrated in FIG. 1 includes a first node 2A (2), a second node 2B (2), a third node 2C (2), a fourth node 2D (2), a fifth node 2E (2), a sixth node 2F (2), a seventh node 2G (2), and a control apparatus 3. For convenience of description, for example, the seven nodes 2 are illustrated in the communication system 1. However, the number of nodes 2 is not limited to this and may be changed as appropriate. Packets transmitted by each of the nodes 2 in the communication system 1 are, for example, a high-priority packet, a low-priority packet, a control packet, and so on. The high-priority packet is, for example, an MFH packet. The low-priority packet is, for example, an MBH packet that has a lower priority than the MFH packet. The control packets is a time packet (described later).

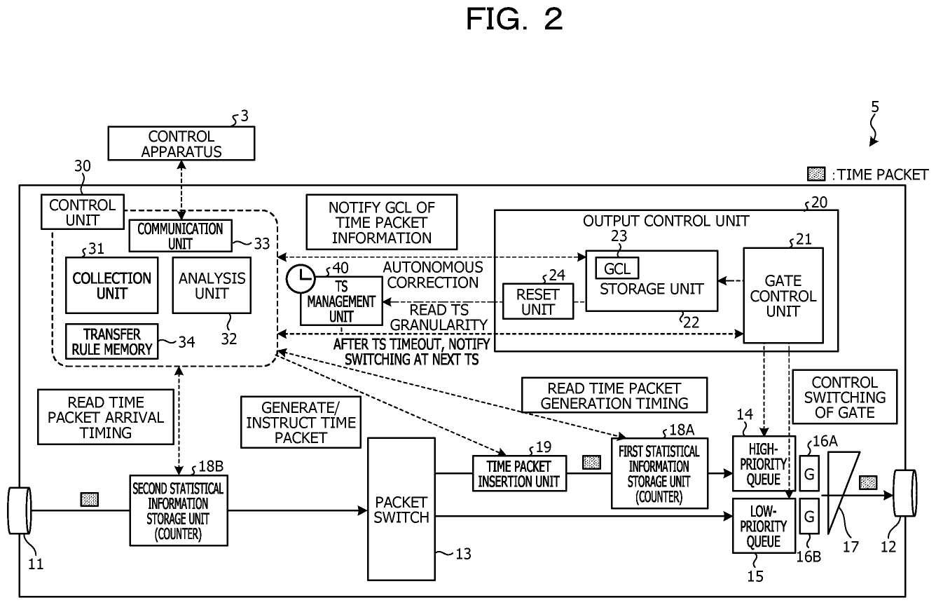

The first node 2A is coupled to the second node 2B and is coupled to the third node 2C. For example, the first node 2A is an edge node coupled to a DetNet 4. The second node 2B is coupled to the first node 2A, is coupled to the fourth node 2D, and is coupled to the fifth node 2E. The third node 2C is coupled to the first node 2A, is coupled to the fourth node 2D, and is coupled to the sixth node 2F. The fourth node 2D is coupled to the second node 2B, is coupled to the third node 2C, is coupled to the fifth node 2E, and is coupled to the sixth node 2F. The fifth node 2E is coupled to the second node 2B, is coupled to the fourth node 2D, and is coupled to the seventh node 2G. The sixth node 2F is coupled to the third node 2C, is coupled to the fourth node 2D, and is coupled to the seventh node 2G. The seventh node 2G is coupled to the fifth node 2E and is coupled to the sixth node 2F. In each of the first to seventh nodes 2, an iTAS apparatus 5 (see FIG. 2) is built in for each port for each coupled path. The control apparatus 3 monitors and controls each of the iTAS apparatuses 5 in the respective nodes 2 in the communication system 1.

A case is assumed where a set path in the communication system 1 is a route of the first node 2A→the second node 2B→the fourth node 2D→the fifth node 2E→the seventh node 2G. In this case, it is assumed that the first node 2A is an edge node, the second node 2B, the fourth node 2D, and the fifth node 2E are intermediate nodes, and the seventh node 2G is a terminal node.

FIG. 2 is an explanatory diagram illustrating an example of a configuration of the iTAS apparatus 5. The iTAS apparatus 5 illustrated in FIG. 2 includes an input port 11, an output port 12, a packet switch 13, a high-priority queue 14, a low-priority queue 15, a high-priority gate 16A, a low-priority gate 16B, and a multiplexer (MUX) 17. The iTAS apparatus 5 includes a first statistical information storage unit 18A, a time packet insertion unit 19, and a second statistical information storage unit 18B. The iTAS apparatus 5 includes an output control unit 20, a control unit 30, and a TS management unit 40.

The input port 11 is a port that is coupled to the iTAS apparatuses 5 in other nodes 2 through various links such as an MBH link and an MFH link and that inputs a packet. The output port 12 is a port that is coupled to the iTAS apparatuses 5 in other nodes 2 through various links such as an MBH link and an MFH link and that outputs a packet. The packet switch 13 identifies a P bit of a virtual local area network (VLAN) tag in a received packet or the like, and based on the identification result, transfers the received packet of a type to the high-priority queue 14 or the low-priority queue 15 corresponding to the type of the received packet. In accordance with the packet types of received packets from the input port 11, the packet switch 13 outputs high-priority packets to the high-priority queue 14 and outputs low-priority packets to the low-priority queue 15.

The high-priority queue 14 is a storage in which high-priority packets from the packet switch 13 are queued. The low-priority queue 15 is a storage in which low-priority packets from the packet switch 13 are queued. The high-priority gate 16A is a gate that performs switching of output of the high-priority queue 14 in units of TSs. The low-priority gate 16B is a gate that performs switching of output of the low-priority queue 15 in units of TSs. When the high-priority gate 16A is in an open state and the low-priority gate 16B is in a closed state, the high-priority gate 16A outputs the high-priority packets stored in the high-priority queue 14 to the MUX 17 and the low-priority gate 16B stops output of the low-priority packets stored in the low-priority queue 15 to the MUX 17. When the high-priority gate 16A is in the closed state and the low-priority gate 16B is in the open state, the low-priority gate 16B outputs the low-priority packets stored in the low-priority queue 15 to the MUX 17 and the high-priority gate 16A stops output of the high-priority packets stored in the high-priority queue 14 to the MUX 17. The MUX 17 selectively outputs output packets of the high-priority gate 16A and the low-priority gate 16B. The MUX 17 adds a media access control (MAC) address to the output packets, and outputs the MAC-address-added output packets to the output port 12.

The first statistical information storage unit 18A is an area that stores, as statistical information, a periodic pattern of received packets. In response to a time packet transmission start request, the time packet insertion unit 19 generates a time packet and outputs the generated time packet to the high-priority queue 14. The time packet transmission start request is a request from the control apparatus 3 to the edge node in the set path. The second statistical information storage unit 18B is an area that stores, as statistical information, reception timings of a time packet and received packets from other nodes 2 received from the input port 11. The time packet is a control packet used for establishing synchronization of TS numbers used by the individual iTAS apparatuses 5 in the respective nodes 2 in the set path when the control apparatus 3 performs path setting. The packet switch 13 and the time packet insertion unit 19 serve as a transmission unit configured to transmit a time packet for resetting the time slot number currently counted in each iTAS apparatus 5 in the set path, in a forward direction of the set path in accordance with a predetermined timing. The transmission unit is configured to, in response to receipt of the time packet from the forward direction of the set path, transmit this time packet in the forward direction of the set path.

The control unit 30 controls the entire iTAS apparatus 5. The control unit 30 includes a collection unit 31, an analysis unit 32, a communication unit 33, and a transfer rule memory 34. The collection unit 31 collects statistical information of received packets. The statistical information is an amount of packets received in each time slot. The amount of packets is, for example, the number of packets or the number of bytes. The analysis unit 32 analyzes the statistical information of the received packets and identifies a periodicity pattern of the received packets, such as the periodicity and the pattern of the received packets. The analysis unit 32 is trained with an arrival interval (periodicity) of the received packets and a pattern (average arrival amount or burst fluctuation degree) of the received packets. The communication unit 33 communicates with the control apparatus 3 by using a control line. The transfer rule memory 34 is an area that stores a transfer rule to be used when the iTAS apparatus 5 in each of the nodes 2 in the set path (described later) transfers a time packet.

The TS management unit 40 is a counter that counts the current TS number. The output control unit 20 controls the high-priority gate 16A and the low-priority gate 16B in units of TS numbers. The output control unit 20 includes a gate control unit 21, a storage unit 22, and a reset unit 24. Based on switching information of the high-priority gate 16A and the low-priority gate 16B that corresponds to the TS number currently counted, the gate control unit 21 controls switching of the high-priority gate 16A and the low-priority gate 16B. The storage unit 22 includes a GCL 23. The reset unit 24 resets the TS number currently counted.

If the node including this iTAS apparatus 5 is the edge node or the intermediate node, in response to the start of transmission of a time packet, the reset unit 24 resets the TS number currently counted and restarts a count operation of the TS management unit 40. If the node including this iTAS apparatus 5 is the terminal node, in response to receipt of the time packet addressed thereto from the forward direction of the set path, the reset unit 24 resets the TS number currently counted and restarts the count operation of the TS management unit 40.

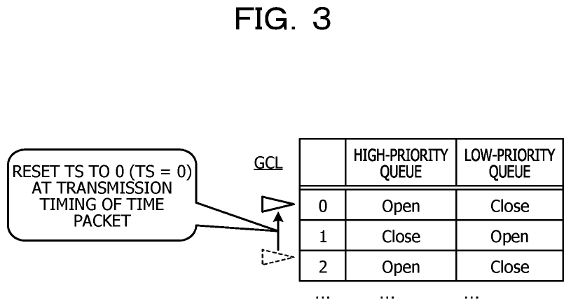

FIG. 3 is an explanatory diagram illustrating an example of the GCL 23. The GCL 23 is a storage unit that manages the switching information of the high-priority gate 16A and the low-priority gate 16B in units of TS numbers for individual packet types of the received packets. The packet types are packet types such as the high-priority packet and the low-priority packet.

Based on an analysis result obtained by the analysis unit 32, the control unit 30 updates the table content of the GCL 23. Based on the periodicity pattern of the received packets, the control unit 30 updates the TS number in the GCL 23 and a stay time for each TS number. Based on the periodicity pattern, the control unit 30 updates the switching information of the high-priority gate 16A and the low-priority gate 16B for each TS number in the GCL 23. Based on the statistical information of the high-priority packets among the received packets, the control unit 30 predicts an arrival timing of a high-priority packet. The switching information indicates set states of the high-priority gate 16A and the low-priority gate 16B, for example, a gate open state and a gate closed state.

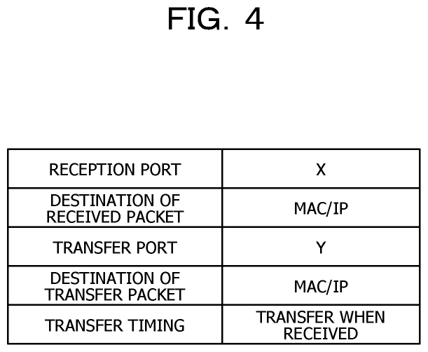

FIG. 4 is an explanatory diagram illustrating an example of the transfer rule. The transfer rule memory 34 is an area that stores the transfer rule used when the corresponding node 2 transfers a time packet. The transfer rule is a transfer rule set by the control apparatus 3 in each of the nodes 2 in the set path at the time of path setting. The transfer rule illustrated in FIG. 4 manages a reception port, a destination of a received packet, a transfer port, a destination of a transfer packet, and a transfer timing in association with each other. The reception port is a port ID for identifying a port that receives a received packet. The destination of the received packet is a MAC/Internet Protocol (IP) address for identifying the iTAS apparatus 5 in the node 2 that is the final destination of the received packet. The transfer port is a port ID for identifying an output port used when the received packet is transferred to the node 2 that is the final destination. The destination of the transfer packet is a MAC/IP address for identifying the iTAS apparatus 5 in the node 2 that is a transfer destination to which the received packet is to be transferred. The transfer timing is a timing at which the received packet is to be transferred.

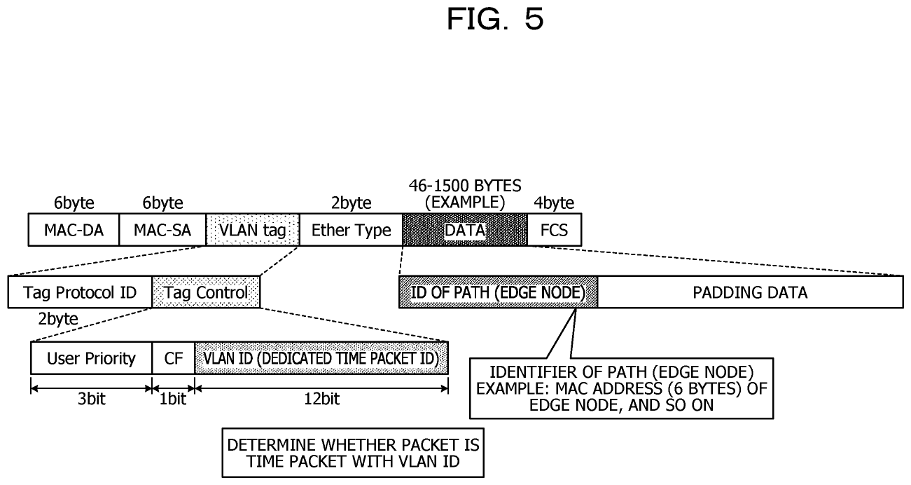

FIG. 5 is an explanatory diagram illustrating an example of a format of the time packet. The time packet illustrated in FIG. 5 includes a MAC-DA, a MAC-SA, a VLAN tag, an Ether type, a data field, and a frame check sequence (FCS). The MAC-DA is a MAC address of the iTAS apparatus 5 in the node 2 that is the destination of the time packet. The MAC-SA is a MAC address of the iTAS apparatus 5 in the node 2 that is the transmission source of the time packet. The VLAN tag is a tag for identifying the time packet. The Ether type is a type code of a protocol. The FCS is a code that enables detection of damaged data in a frame on a reception side.

The VLAN tag includes a tag protocol ID and a tag control. The tag control includes a priority, a canonical format (CF), and a VLAN ID. The priority is a priority of the VLAN. The VLAN ID is a dedicated ID for identifying a time packet defined in the communication system. The data field includes a path ID, and the rest of the field is filled with padding data. The path ID is a MAC address of the edge node in the set path.

The MAC-DA, the MAC-SA, the tag protocol ID in the VLAN tag, the priority and the CF in the tag control in the VLAN tag, and the Ether type in the time packet are copies of the values of the MFH packet already flowing through the path.

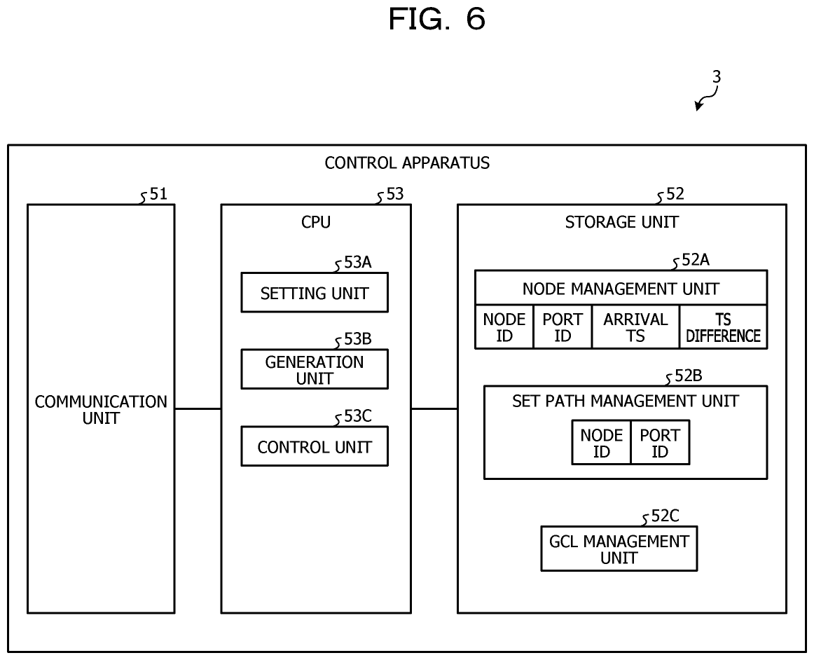

FIG. 6 is an explanatory diagram illustrating an example of a configuration of the control apparatus 3. The control apparatus 3 illustrated in FIG. 6 includes a communication unit 51 that communicates with each of the nodes 2, a storage unit 52 that stores various kinds of information, and a central processing unit (CPU) 53 that controls the entire control apparatus 3. The communication unit 51 communicates with each of the nodes 2 in the communication system 1 by using a control line. The storage unit 52 includes a node management unit 52A, a set path management unit 52B, and a GCL management unit 52C. The node management unit 52A manages a node ID, a port ID, an arrival TS, and a TS difference. The node ID is an ID for identifying the node 2. The port ID is an ID for identifying a port of each iTAS apparatus in the node 2. The arrival TS is a TS number related to a time packet for each iTAS apparatus 5. The arrival TS is, for example, a forward-direction arrival TS, a backward-direction arrival TS, or the like. The TS difference is an amount of transmission delay between different paths for each iTAS apparatus 5. The TS difference is, for example, a forward-direction TS difference, a backward-direction TS difference, or the like.

The set path management unit 52B includes a node ID and a port ID. The node ID is an ID for identifying each of the nodes 2 in the set path. The port ID is an ID for identifying a port of the iTAS apparatus 5 in each of the nodes 2 in the set path. The GCL management unit 52C is a table that manages the GCL 23 of the edge node in the set path.

The CPU 53 includes a setting unit 53A, a generation unit 53B, and a control unit 53C. When setting the set path, the setting unit 53A sets the transfer rule in the iTAS apparatus 5 in each of the nodes 2 in the set path and requests the edge node in the set path to start transmitting a time packet.

When receiving an arrival TS or a TS difference from the iTAS apparatus 5 in each of the nodes 2 in the set path, the generation unit 53B generates the GCL 23 of the edge node in the set path, based on the arrival TS and the TS difference of each iTAS apparatus 5. The arrival TS includes, for example, a forward-direction arrival TS related to a forward-direction time packet of each of the nodes 2 in the set path and a backward-direction arrival TS related to a backward-direction time packet of each of the nodes 2 in the set path. The forward-direction arrival TS is a timing at which the reset unit 24 sets the TS number currently counted to 0 in response to the forward-direction time packet. The backward-direction arrival TS is a timing at which the reset unit 24 sets the TS number currently counted to 0 in response to the backward-direction time packet. The control unit 53C controls the entire CPU 53.

### [First TS Synchronization Process]

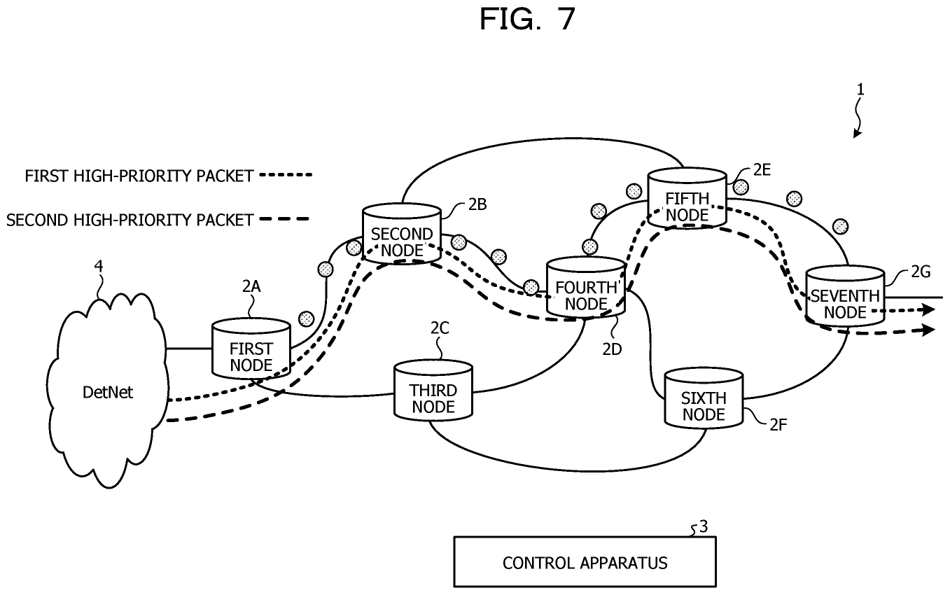

FIG. 7 is an explanatory diagram illustrating an example of the communication system 1 at the time of path setting. A case is assumed where the control apparatus 3 sets a low-delay path for transmitting a first high-priority packet and a second high-priority packet through a route of the first node 2A→the second node 2B→the fourth node 2D→the fifth node 2E→the seventh node 2G. The control apparatus 3 sets a transfer rule of a time packet in the iTAS apparatus 5 in each of the nodes 2 in the set path. Each iTAS apparatus 5 receives the transfer rule from the control apparatus 3 by using the control line, and stores the received transfer rule in the transfer rule memory 34. A first TS synchronization process is a process of synchronizing TS numbers used in the individual nodes 2 in the set path.

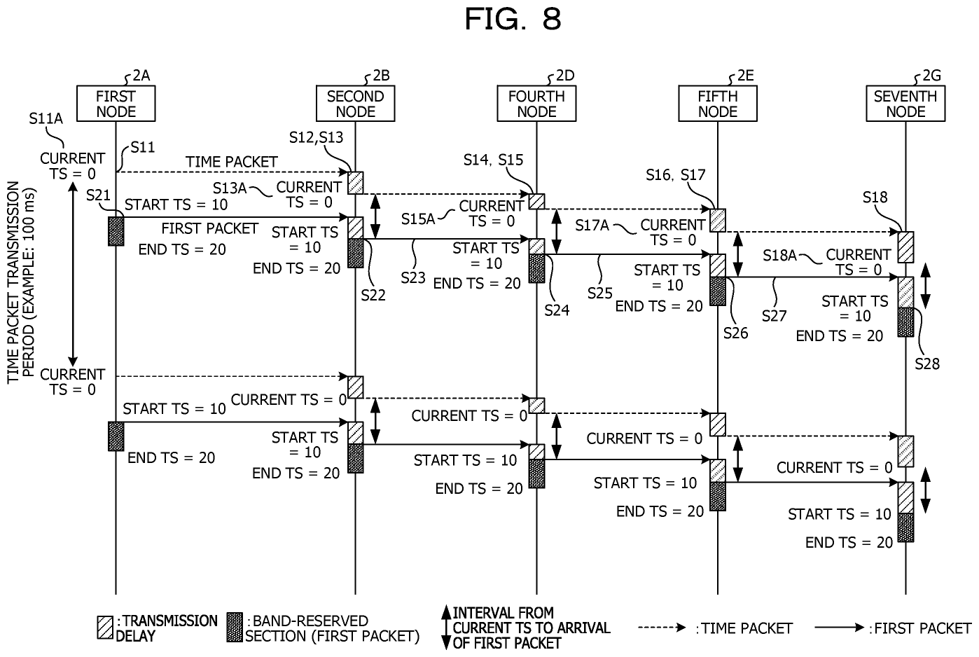

FIG. 8 is a sequence diagram illustrating an example of a processing operation of the iTAS apparatus 5 in each of the nodes 2 related to the first TS synchronization process. The control apparatus 3 instructs the iTAS apparatus 5 in the first node 2A which is the edge node in the set path to transmit a time packet. Based on the set transfer rule, the iTAS apparatus 5 in the first node 2A generates a forward-direction time packet in response to the transmission start request from the control apparatus 3, and transmits the generated time packet to the second node 2B that is adjacent in the forward direction of the set path (operation S11). The forward direction of the set path is a direction of the first node 2A→the second node 2B→the fourth node 2D→the fifth node 2E→the seventh node 2G. At this time, the reset unit 24 in the iTAS apparatus 5 in the first node 2A sets the TS number currently counted to 0 in response to a start of the transmission of the forward-direction time packet (operation S11A). The control unit 30 in the iTAS apparatus 5 in the first node 2A notifies the control apparatus 3 of the timing of TS number=0 as a forward-direction arrival TS. In response to the forward-direction arrival TS from the iTAS apparatus 5 in the first node 2A, the control apparatus 3 may recognize the arrival of the forward-direction time packet at the iTAS apparatus 5 in the first node 2A.

The iTAS apparatus 5 in the second node 2B in the set path receives the forward-direction time packet from the iTAS apparatus 5 in the first node 2A (operation S12). When receiving the forward-direction time packet from the first node 2A, the iTAS apparatus 5 in the second node 2B transmits this received time packet to the fourth node 2D that is adjacent in the forward direction of the set path, based on the transfer rule of the set path (operation S13). At this time, the reset unit 24 in the iTAS apparatus 5 in the second node 2B sets the TS number currently counted to 0 in response to a start of the transmission of the forward-direction time packet (operation S13A). As a result, the control unit 30 in the iTAS apparatus 5 in the second node 2B sets the TS number currently counted to 0 in consideration of a forward-direction transmission delay from the first node 2A to the second node 2B. The control unit 30 in the iTAS apparatus 5 in the second node 2B notifies the control apparatus 3 of the timing of TS number=0 as a forward-direction arrival TS. In response to the forward-direction arrival TS from the iTAS apparatus 5 in the second node 2B, the control apparatus 3 may recognize the arrival of the forward-direction time packet at the iTAS apparatus 5 in the second node 2B.

The iTAS apparatus 5 in the fourth node 2D in the set path receives the forward-direction time packet from the iTAS apparatus 5 in the second node 2B (operation S14). When receiving the forward-direction time packet from the second node 2B, the iTAS apparatus 5 in the fourth node 2D transmits this received time packet to the fifth node 2E that is adjacent in the forward direction of the set path, based on the transfer rule of the set path (operation S15). At this time, the reset unit 24 in the iTAS apparatus 5 in the fourth node 2D sets the TS number currently counted to 0 in response to a start of the transmission of the forward-direction time packet (operation S15A). As a result, the control unit 30 in the iTAS apparatus 5 in the fourth node 2D sets the TS number currently counted to 0 in consideration of a forward-direction transmission delay from the second node 2B to the fourth node 2D. The control unit 30 in the iTAS apparatus 5 in the fourth node 2D notifies the control apparatus 3 of the timing of TS number=0 as a forward-direction arrival TS. In response to the forward-direction arrival TS from the iTAS apparatus 5 in the fourth node 2D, the control apparatus 3 may recognize the arrival of the forward-direction time packet at the iTAS apparatus 5 in the fourth node 2D.

The iTAS apparatus 5 in the fifth node 2E in the set path receives the forward-direction time packet from the iTAS apparatus 5 in the fourth node 2D (operation S16). When receiving the forward-direction time packet from the fourth node 2D, the iTAS apparatus 5 in the fifth node 2E transmits this received time packet to the seventh node 2G that is adjacent in the forward direction of the set path, based on the transfer rule of the set path (operation S17). At this time, the reset unit 24 in the iTAS apparatus 5 in the fifth node 2E sets the TS number currently counted to 0 in response to a start of the transmission of the forward-direction time packet (operation S17A). As a result, the control unit 30 in the iTAS apparatus 5 in the fifth node 2E sets the TS number currently counted to 0 in consideration of a forward-direction transmission delay from the fourth node 2D to the fifth node 2E. The control unit 30 in the iTAS apparatus 5 in the fifth node 2E notifies the control apparatus 3 of the timing of TS number=0 as a forward-direction arrival TS. In response to the forward-direction arrival TS from the iTAS apparatus 5 in the fifth node 2E, the control apparatus 3 may recognize the arrival of the forward-direction time packet at the iTAS apparatus 5 in the fifth node 2E.

The iTAS apparatus 5 in the seventh node 2G in the set path receives the forward-direction time packet from the iTAS apparatus 5 in the fifth node 2E (operation S18). At this time, the reset unit 24 in the iTAS apparatus 5 in the seventh node 2G sets the TS number currently counted to 0 in response to receipt of the forward-direction time packet (operation S18A). As a result, the control unit 30 in the iTAS apparatus 5 in the seventh node 2G sets the TS number currently counted to 0 in consideration of a forward-direction transmission delay from the fifth node 2E to the seventh node 2G. The control unit 30 in the iTAS apparatus 5 in the seventh node 2G notifies the control apparatus 3 of the timing of TS number=0 as a forward-direction arrival TS. In response to the forward-direction arrival TS from the iTAS apparatus 5 in the seventh node 2G, the control apparatus 3 may recognize the arrival of the forward-direction time packet at the iTAS apparatus 5 in the seventh node 2G.

The iTAS apparatus 5 in the seventh node 2G generates a backward-direction time packet, and transmits the backward-direction time packet to the fifth node 2E that is adjacent in a backward direction of the set path. It is assumed that the iTAS apparatus 5 in the seventh node 2G that transmits the backward-direction time packet is different from the iTAS apparatus 5 in the seventh node 2G that receives the forward-direction time packet. The backward direction of the set path is a direction of the seventh node 2G→the fifth node 2E→the fourth node 2D→the second node 2B→the first node 2A. At this time, the reset unit 24 in the iTAS apparatus 5 in the seventh node 2G sets the backward-direction TS number currently counted to 0 in response to a start of the transmission of the backward-direction time packet. The control unit 30 in the iTAS apparatus 5 in the seventh node 2G notifies the control apparatus 3 of the timing of TS number=0 as a backward-direction arrival TS. In response to the backward-direction arrival TS from the iTAS apparatus 5 in the seventh node 2G, the control apparatus 3 may recognize the arrival of the backward-direction time packet at the iTAS apparatus 5 in the seventh node 2G.

The iTAS apparatus 5 in the fifth node 2E in the set path receives the backward-direction time packet from the iTAS apparatus 5 in the seventh node 2G. It is assumed that the iTAS apparatus 5 in the fifth node 2E that receives the backward-direction time packet is different from the iTAS apparatus 5 in the fifth node 2E that receives the forward-direction time packet. When receiving the backward-direction time packet from the seventh node 2G, the iTAS apparatus 5 in the fifth node 2E transmits this received time packet to the fourth node 2D that is adjacent in the backward direction of the set path, based on the transfer rule of the set path. At this time, the reset unit 24 in the iTAS apparatus 5 in the fifth node 2E sets the backward-direction TS number currently counted to 0 in response to a start of the transmission of the backward-direction time packet. As a result, the control unit 30 in the iTAS apparatus 5 in the fifth node 2E sets the backward-direction TS number currently counted to 0 in consideration of a backward-direction transmission delay from the seventh node 2G to the fifth node 2E. The control unit 30 in the iTAS apparatus 5 in the fifth node 2E notifies the control apparatus 3 of the timing of TS number=0 as a backward-direction arrival TS. In response to the backward-direction arrival TS from the iTAS apparatus 5 in the fifth node 2E, the control apparatus 3 may recognize the arrival of the backward-direction time packet at the iTAS apparatus 5 in the fifth node 2E.

The iTAS apparatus 5 in the fourth node 2D in the set path receives the backward-direction time packet from the iTAS apparatus 5 in the fifth node 2E. It is assumed that the iTAS apparatus 5 in the fourth node 2D that receives the backward-direction time packet is different from the iTAS apparatus 5 in the fourth node 2D that receives the forward-direction time packet. When receiving the backward-direction time packet from the fifth node 2E, the iTAS apparatus 5 in the fourth node 2D transmits this received time packet to the second node 2B that is adjacent in the backward direction of the set path, based on the transfer rule of the set path. At this time, the reset unit 24 in the iTAS apparatus 5 in the fourth node 2D sets the backward-direction TS number currently counted to 0 in response to a start of the transmission of the backward-direction time packet. As a result, the control unit 30 in the iTAS apparatus 5 in the fourth node 2D sets the backward-direction TS number currently counted to 0 in consideration of a backward-direction transmission delay from the fifth node 2E to the fourth node 2D. The control unit 30 in the iTAS apparatus 5 in the fourth node 2D notifies the control apparatus 3 of the timing of TS number=0 as a backward-direction arrival TS. In response to the backward-direction arrival TS from the iTAS apparatus 5 in the fourth node 2D, the control apparatus 3 may recognize the arrival of the backward-direction time packet at the iTAS apparatus 5 in the fourth node 2D.

The iTAS apparatus 5 in the second node 2B in the set path receives the backward-direction time packet from the iTAS apparatus 5 in the fourth node 2D. It is assumed that the iTAS apparatus 5 in the second node 2B that receives the backward-direction time packet is different from the iTAS apparatus 5 in the second node 2B that receives the forward-direction time packet. When receiving the backward-direction time packet from the fourth node 2D, the iTAS apparatus 5 in the second node 2B transmits this received time packet to the first node 2A that is adjacent in the backward direction of the set path, based on the transfer rule of the set path. At this time, the reset unit 24 in the iTAS apparatus 5 in the second node 2B sets the backward-direction TS number currently counted to 0 in response to a start of the transmission of the backward-direction time packet. As a result, the control unit 30 in the iTAS apparatus 5 in the second node 2B sets the backward-direction TS number currently counted to 0 in consideration of a backward-direction transmission delay from the fourth node 2D to the second node 2B. The control unit 30 in the iTAS apparatus 5 in the second node 2B notifies the control apparatus 3 of the timing of TS number=0 as a backward-direction arrival TS. In response to the backward-direction arrival TS from the iTAS apparatus 5 in the second node 2B, the control apparatus 3 may recognize the arrival of the backward-direction time packet at the iTAS apparatus 5 in the second node 2B.

The iTAS apparatus 5 in the first node 2A in the set path receives the time packet from the iTAS apparatus 5 in the second node 2B. It is assumed that the iTAS apparatus 5 in the first node 2A that receives the backward-direction time packet is different from the iTAS apparatus 5 in the first node 2A that transmits the forward-direction time packet. At this time, the reset unit 24 in the iTAS apparatus 5 in the first node 2A sets the backward-direction TS number currently counted to 0 in response to receipt of the backward-direction time packet from the second node 2B. As a result, the control unit 30 in the iTAS apparatus 5 in the first node 2A sets the backward-direction TS number currently counted to 0 in consideration of a backward-direction transmission delay from the second node 2B to the first node 2A. The control unit 30 in the iTAS apparatus 5 in the first node 2A notifies the control apparatus 3 of the timing of TS number=0 as a backward-direction arrival TS. In response to the backward-direction arrival TS from the iTAS apparatus 5 in the first node 2A, the control apparatus 3 may recognize the arrival of the backward-direction time packet at the iTAS apparatus 5 in the first node 2A.

The control apparatus 3 stores, in the node management unit 52A, the forward-direction arrival TSs from the respective nodes 2 in the set path and the backward-direction arrival TSs from the respective nodes 2 in the set path. Based on the forward-direction arrival TSs and the backward-direction arrival TSs in the node management unit 52A, the control apparatus 3 generates the GCL of the edge node in the set path and sets the generated GCL in the edge node.

Based on the forward-direction arrival TSs of the respective nodes 2 in the set path, the control apparatus 3 corrects a TS range of a start TS and an end TS of each user packet in the GCL, and sets the GCL including the corrected TS range in the first node 2A that is the edge node in the forward direction in the set path. Based on the backward-direction arrival TSs of the respective nodes 2 in the set path, the control apparatus 3 corrects a TS range of a start TS and an end TS of each user packet in the GCL, and sets the GCL including the corrected TS range in the seventh node 2G that is the edge node in the backward direction in the set path.

Each of the nodes 2 in the set path synchronizes the TS numbers between the iTAS apparatuses 5 used for bidirectional communication in the set path. The control apparatus 3 requests the edge node in the set path to start transmitting a time packet. However, the control apparatus 3 may request the edge node to start transmitting a time packet every transmission period that is a predetermined timing. As a result, each of the nodes 2 in the set path regularly synchronizes the TS numbers between the iTAS apparatuses 5 used for bidirectional communication in the set path. The edge node may autonomously start transmission of a time packet every transmission period, which may be changed as appropriate.

The iTAS apparatus 5 in each of the nodes 2 in the set path sets the TS range for each user packet in the GCL 23. The TS range for each user packet corresponds to a start TS and an end TS, and is a TS range in which switching is performed on the output of the high-priority gate 16A and the output of the low-priority gate 16B. For example, it is assumed that among the high-priority packets, the start TS and the end TS of the first high-priority packet are 10 and 20, respectively, and the start TS and the end TS of the second high-priority packet are 30 and 35, respectively.

Because the TS numbers currently counted are synchronized with each other, the iTAS apparatus 5 in each of the nodes 2 in the set path controls switching of the output of the high-priority gate 16A and the output of the low-priority gate 16B, based on the switching information of the high-priority gate 16A and the low-priority gate 16B for each TS number in the GCL 23.

Out-of-order user packets are input from the DetNet to the iTAS apparatus 5 in the first node 2A in the set path. Immediately after the TS number is set to 0, the iTAS apparatus 5 in the first node 2A starts counting, and based on the switching information in the GCL 23, sets the high-priority gate 16A in the open state and sets the low-priority gate 16B in the closed state at a timing when the TS number currently counted is 10. For example, the iTAS apparatus 5 in the first node 2A transmits the first high-priority packet to the iTAS apparatus 5 in the second node 2B when the TS number currently counted is in a range of 10 to 20 (operation S21). The iTAS apparatus 5 in the second node 2B receives the first high-priority packet from the iTAS apparatus 5 in the first node 2A (operation S22). When receiving the first high-priority packet, the iTAS apparatus 5 in the second node 2B sets the high-priority gate 16A in the open state and sets the low-priority gate 16B in the closed state at the timing when the TS number currently counted is 10. For example, the iTAS apparatus 5 in the second node 2B transmits the first high-priority packet to the iTAS apparatus 5 in the fourth node 2D when the TS number currently counted is in the range of 10 to 20 (operation S23).

The iTAS apparatus 5 in the fourth node 2D receives the first high-priority packet from the iTAS apparatus 5 in the second node 2B (operation S24). When receiving the first high-priority packet, the iTAS apparatus 5 in the fourth node 2D sets the high-priority gate 16A in the open state and sets the low-priority gate 16B in the closed state at the timing when the TS number currently counted is 10. For example, the iTAS apparatus 5 in the fourth node 2D transmits the first high-priority packet to the iTAS apparatus 5 in the fifth node 2E when the TS number currently counted is in the range of 10 to 20 (operation S25).

The iTAS apparatus 5 in the fifth node 2E receives the first high-priority packet from the iTAS apparatus 5 in the fourth node 2D (operation S26). When receiving the first high-priority packet, the iTAS apparatus 5 in the fifth node 2E sets the high-priority gate 16A in the open state and sets the low-priority gate 16B in the closed state at the timing when the TS number currently counted is 10. For example, the iTAS apparatus 5 in the fifth node 2E transmits the first high-priority packet to the iTAS apparatus 5 in the seventh node 2G when the TS number currently counted is in the range of 10 to 20 (operation S27). The iTAS apparatus 5 in the seventh node 2G receives the user packet from the iTAS apparatus 5 in the fifth node 2E (operation S28).

As a result, the individual nodes 2 in the set path synchronize the forward-direction TS numbers between the iTAS apparatuses 5 in the respective nodes 2 in the set path, so that congestion of the high-priority packets in the forward direction may be avoided. Likewise, the individual nodes 2 in the set path synchronize the backward-direction TS numbers used between the iTAS apparatuses 5 in the respective nodes 2 in the set path, so that congestion of the high-priority packets in the backward direction may be avoided.

Out-of-order packets flow into the edge node from the DetNet 4. However, the packets are rectified in accordance with the switching information for each TS reserved by the edge node. Since the TS numbers are synchronized with each other in all the nodes 2 in the set path, the high-priority packets may be transmitted based on the switching information for each TS reserved by each of the nodes 2 without directly setting the TS in the non-edge nodes.

By correcting the switching information of each high-priority packet for each TS number in the GCL 23, based on the periodicity of the high-priority packets among the received packets, the iTAS apparatus 5 in each of the nodes 2 in the set path may suppress fluctuations in the output timings of the individual high-priority packets.

The iTAS apparatus 5 in the first node 2A in the set path transmits a time packet to the set path with a transmission period that is a predetermined timing. The iTAS apparatus 5 in each of the nodes 2 in the set path sets the current TS number being counted to 0 every transmission period. The transmission period of the time packet is a period sufficient for correcting a frequency deviation, for example, a delay upper limit. The delay upper limit is an upper-limit time until a packet arrives at the seventh node 2G from the first node 2A in the set path, and is in a range of 100 to 4000000 μs according to the specification of iTAS. Fluctuations in transmission and arrival timings of time packets are to be sufficiently small relative to the TS, which is the smallest units of reservation. Thus, the iTAS apparatus 5 is used in training of the transmission and arrival patterns of the time packets. As in the case of fluctuations in the time packets, the iTAS apparatus 5 is used for fluctuations in transmission and arrival timings of the user packets.

The forward-direction TS numbers and the backward-direction TS numbers used are synchronized between the iTAS apparatuses 5 in the respective nodes 2 in the same set path in first TS synchronization process. As a result, congestion of high-priority packets in the same set path may be avoided. [Second TS Synchronization Process]

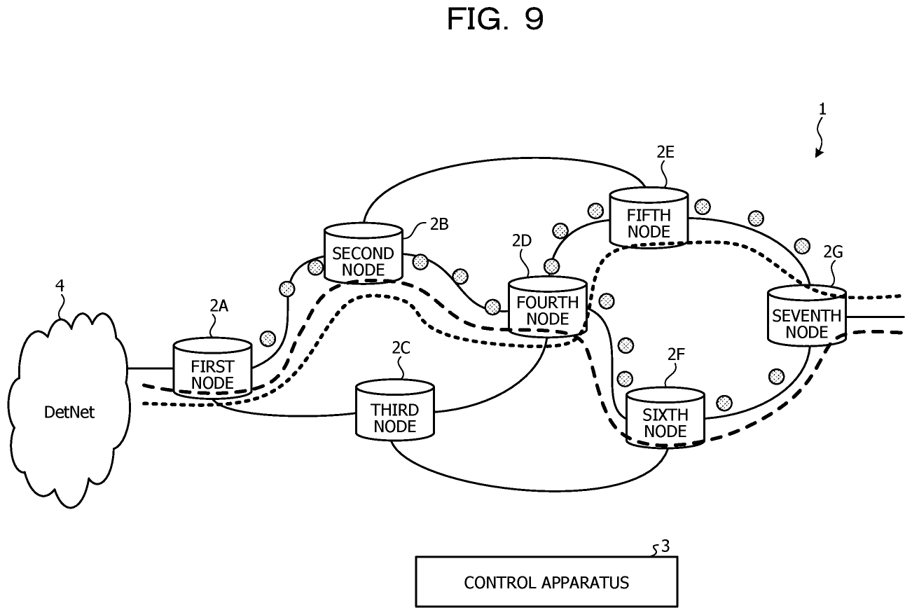

A second TS synchronization process performed when a new second set path is added to the first set path will be described next. FIG. 9 is an explanatory diagram illustrating an example of the communication system 1 in a state in which the second set path is added to the first set path. The first set path is a route of the first node 2A→the second node 2B→the fourth node 2D→the fifth node 2E→the seventh node 2G. The second set path is a route of the first node 2A→the second node 2B→the fourth node 2D→the sixth node 2F→the seventh node 2G. It is assumed that the control apparatus 3 adds the second set path to the first set path. For example, in the iTAS apparatus 5 of the seventh node 2G, a plurality of time packets are input to one port. A case is assumed where a first high-priority packet flows through the first set path and a second high-priority packet flows through the second set path.

The control apparatus 3 recognizes that a time packet does not pass through the iTAS apparatus 5 in the sixth node 2F in the second set path. Thus, the control apparatus 3 sets a transfer rule from the iTAS apparatus 5 in the fourth node 2D to the iTAS apparatus 5 in the sixth node 2F, in the iTAS apparatus 5 in the fourth node 2D by using a control line. The control apparatus 3 sets a transfer rule from the iTAS apparatus 5 in the sixth node 2F to the iTAS apparatus 5 in the fourth node 2D, in the iTAS apparatus 5 in the sixth node 2F by using a control line. The control apparatus 3 sets a transfer rule from the iTAS apparatus 5 in the sixth node 2F to the iTAS apparatus 5 in the seventh node 2G, in the iTAS apparatus 5 in the sixth node 2F by using the control line. The control apparatus 3 sets a transfer rule from the iTAS apparatus 5 in the seventh node 2G to the iTAS apparatus 5 in the sixth node 2F, in the iTAS apparatus 5 in the seventh node 2G by using a control line.

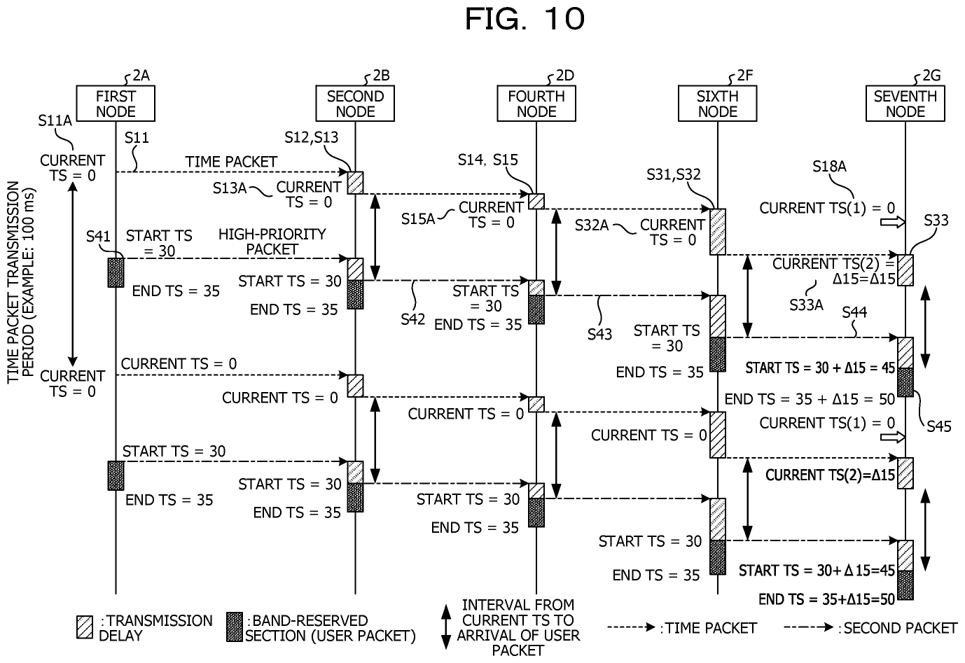

FIG. 10 is a sequence diagram illustrating an example of a processing operation of the iTAS apparatus 5 in each of the nodes 2 in the second set path related to the second TS synchronization process. For convenience of description, it is assumed that the first high-priority packet is transferred through the first set path in the forward direction when the TS number is in a range of 10 to 20 and the second high-priority packet is transferred through the second set path in the forward direction when the TS number is in a range of 30 to 35.

Based on a timing related to a forward-direction time packet, the reset unit 24 in each iTAS apparatus 5 in each of the nodes 2 (2A, 2B, 2D, 2E, and 2G) in the first set path sets the forward-direction TS number currently counted to 0. As a result, each iTAS apparatus 5 in each of the nodes 2 in the first set path outputs the first high-priority packet at a timing when the TS number is in the range of 10 to 20 by using the TS number (TS=0) counted as a start point.

The control apparatus 3 requests the iTAS apparatus 5 in the first node 2A to start transmitting a forward-direction time packet by using the control line. When receiving the forward-direction time packet transmission start request from the control apparatus 3, the iTAS apparatus 5 in the first node 2A transmits the forward-direction time packet to the iTAS apparatus 5 in the second node 2B, based on the transfer rule (operation S11). The reset unit 24 in the iTAS apparatus 5 in the first node 2A sets the TS number currently counted to 0 in response to a start of the transmission of the forward-direction time packet (operation S11A). The iTAS apparatus 5 in the first node 2A notifies the control apparatus 3 of the timing of TS number=0 as a forward-direction arrival TS.

When receiving the forward-direction time packet from the first node 2A (operation S12), the iTAS apparatus 5 in the second node 2B transmits this time packet to the iTAS apparatus 5 in the fourth node 2D, based on the transfer rule (operation S13). The reset unit 24 in the iTAS apparatus 5 in the second node 2B sets the TS number currently counted to 0 in response to a start of the transmission of the forward-direction time packet (operation S13A). The iTAS apparatus 5 in the second node 2B notifies the control apparatus 3 of the timing of TS number=0 as a forward-direction arrival TS.

When receiving the forward-direction time packet from the second node 2B (operation S14), the iTAS apparatus 5 in the fourth node 2D transmits this time packet to the iTAS apparatus 5 in the sixth node 2F, based on the transfer rule (operation S15). The iTAS apparatus 5 in the fourth node 2D sets the current TS number currently counted to 0, in response to a start of the transmission of the forward-direction time packet (operation S15A). The iTAS apparatus 5 in the fourth node 2D notifies the control apparatus 3 of the timing of TS number=0 as a forward-direction arrival TS.

When receiving the forward-direction time packet from the fourth node 2D (operation S31), the iTAS apparatus 5 in the sixth node 2F transmits this time packet to the iTAS apparatus 5 in the seventh node 2G, based on the transfer rule (operation S32). The reset unit 24 in the iTAS apparatus 5 in the sixth node 2F sets the TS number currently counted to 0 in response to a start of the transmission of the forward-direction time packet (operation S32A). The iTAS apparatus 5 in the sixth node 2F notifies the control apparatus 3 of the timing of TS number=0 as a forward-direction arrival TS.

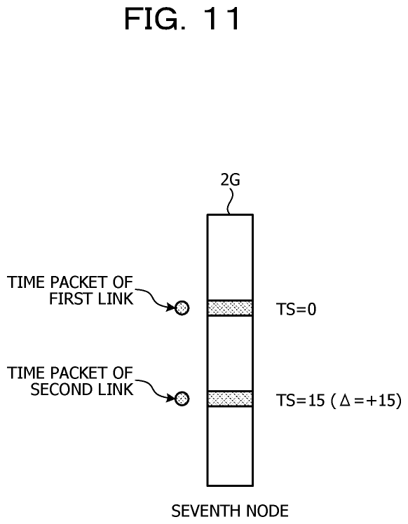

When receiving the forward-direction time packet from the sixth node 2F (operation S33), the iTAS apparatus 5 in the seventh node 2G obtains the TS number currently counted (a forward-direction arrival TS of a second link) from a forward-direction arrival TS (TS=0) of a first link (operation S33A). FIG. 11 is an explanatory diagram illustrating an example of a TS difference that occurs in the terminal node. It is assumed that the terminal node is the seventh node 2G in the set path illustrated in FIG. 9. The iTAS apparatus 5 in the seventh node 2G notifies the control apparatus 3 of the forward-direction arrival TS of the first link and the forward-direction arrival TS of the second link. The iTAS apparatus 5 in the seventh node 2G calculates a forward-direction TS difference with (the forward-direction arrival TS of the second link−the forward-direction arrival TS of the first link), and notifies the control apparatus 3 of the forward-direction TS difference. The first link corresponds to the first set path, and the second link corresponds to the second set path. The forward-direction TS difference is an amount of transmission delay between the first link and the second link.

Based on the forward-direction arrival TS of the first link and the forward-direction arrival TS of the second link of each of the nodes 2 and the forward-direction TS difference (Δ15), the control apparatus 3 corrects the switching information of the second high-priority packet in the forward direction. The control apparatus 3 sets the corrected switching information of the second high-priority packet. For example, the start TS of the second high-priority packet is corrected to 30+Δ5=45 and the end TS of the second high-priority packet is corrected to 35+Δ5=50. The GCL after the correction serves as the switching information for outputting the second high-priority packet when the TS number is in a range of 45 to 50.

The control apparatus 3 stores, in the node management unit 52A, the forward-direction arrival TS of each of the nodes 2 in the set path, the backward-direction arrival TS of each of the nodes 2 in the set path, the forward-direction TS difference, and the backward-direction TS difference. Based on the forward-direction arrival TS, the backward-direction arrival TS, the forward-direction TS difference, and the backward-direction TS difference in the node management unit 52A, the control apparatus 3 generates the GCL of the edge node in the set path, and sets the generated GCL in the edge node.

For example, the control apparatus 3 corrects the TS range of the start TS and the end TS of each user packet in the GCL, based on the forward-direction arrival TS of each of the nodes 2 in the set path and the forward-direction TS difference. The control apparatus 3 sets the GCL including the corrected TS range in the first node 2A that is the edge node in the forward direction in the set path. The control apparatus 3 corrects the TS range of the start TS and the end TS of each user packet in the GCL, based on the backward-direction arrival TS of each of the nodes 2 in the set path and the backward-direction TS difference. The control apparatus 3 sets the GCL including the corrected TS range in the seventh node 2G that is the edge node in the backward direction in the set path. As a result, each of the nodes 2 in the set path synchronizes the TS numbers between the iTAS apparatuses 5 used for bidirectional communication in the set path while taking into account a transmission delay, so that congestion of the high-priority packets may be avoided.

For convenience of description, the case is exemplified where the TS numbers used in the forward-direction set path of the first node 2A→the second node 2B→the fourth node 2D→the sixth node 2F→the seventh node 2G are synchronized in the respective nodes 2 in the second set path. Likewise, for the backward-direction set path of the seventh node 2G→the sixth node 2F→the fourth node 2D→the second node 2B→the first node 2A, the control apparatus 3 requests the iTAS apparatus 5 in the seventh node 2G to start transmitting a backward-direction time packet. As a result, the TS numbers used in the backward-direction set path of the seventh node 2G→the sixth node 2F→the fourth node 2D→the second node 2B→the first node 2A are synchronized also in the iTAS apparatuses 5 in the respective nodes 2 in the backward-direction second set path. Thus, the individual nodes 2 in the backward-direction second set path synchronize the TS numbers between the iTAS apparatuses 5 used for communication in the backward direction.

Immediately after the TS number is set to 0, the iTAS apparatus 5 in the first node 2A starts counting, and based on the switching information in the GCL 23, sets the high-priority gate 16A in the open state and sets the low-priority gate 16B in the closed state at a timing when the TS number currently counted is 30. For example, the iTAS apparatus 5 in the first node 2A transmits the second high-priority packet to the iTAS apparatus 5 in the second node 2B when the TS number currently counted is in the range of 30 to 35 (operation S41).

Immediately after the TS number is set to 0, the iTAS apparatus 5 in the second node 2B starts counting, and based on the switching information in the GCL 23, sets the high-priority gate 16A in the open state and sets the low-priority gate 16B in the closed state at a timing when the TS number currently counted is 30. For example, the iTAS apparatus 5 in the second node 2B transmits the second high-priority packet to the iTAS apparatus 5 in the fourth node 2D when the TS number currently counted is in the range of 30 to 35 (operation S42).

Immediately after the TS number is set to 0, the iTAS apparatus 5 in the fourth node 2D starts counting, and based on the switching information in the GCL 23, sets the high-priority gate 16A in the open state and sets the low-priority gate 16B in the closed state at a timing when the TS number currently counted is 30. For example, the iTAS apparatus 5 in the fourth node 2D transmits the second high-priority packet to the iTAS apparatus 5 in the sixth node 2F when the TS number currently counted is in the range of 30 to 35 (operation S43).

Immediately after the TS number is set to 0, the iTAS apparatus 5 in the sixth node 2F starts counting, and based on the switching information in the GCL 23, sets the high-priority gate 16A in the open state and sets the low-priority gate 16B in the closed state at a timing when the TS number currently counted is 30. For example, the iTAS apparatus 5 in the sixth node 2F transmits the second high-priority packet to the iTAS apparatus 5 in the seventh node 2G when the TS number currently counted is in the range of 30 to 35 (operation S44).

Immediately after the TS number is set to 0, the iTAS apparatus 5 in the seventh node 2G starts counting, and based on the switching information in the GCL 23, sets the high-priority gate 16A in the open state and sets the low-priority gate 16B in the closed state at a timing when the TS number currently counted is 45. For example, the iTAS apparatus 5 in the seventh node 2G receives the second high-priority packet when the TS number currently counted is in the range of 45 to 50 (operation S45).

The individual iTAS apparatuses 5 in the first node 2A, the second node 2B, the fourth node 2D, the fifth node 2E, and the seventh node 2G in the first set path set the high-priority gate 16A in the open state and the low-priority gate 16B in the closed state when the TS number currently counted is in the range of 10 to 20. The iTAS apparatuses 5 in the first node 2A, the second node 2B, the fourth node 2D, and the sixth node 2F in the second set path set the high-priority gate 16A in the open state and the low-priority gate 16B in the closed state when the TS number currently counted is in the range of 30 to 35. The iTAS apparatus 5 in the seventh node 2G in the second set path sets the high-priority gate 16A in the open state and sets the low-priority gate 16B in the closed state when the TS number currently counted is in the range of 45 to 50.

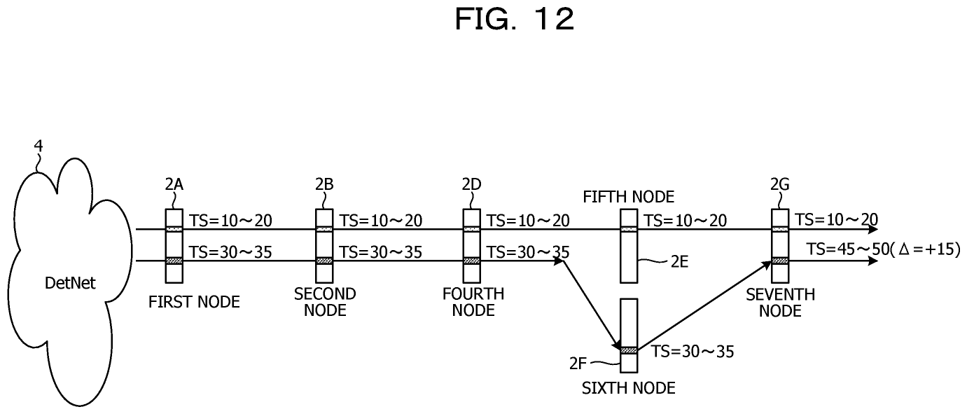

FIG. 12 is an explanatory diagram illustrating an example of TS ranges of the first high-priority packet and the second high-priority packet in each of the nodes 2 illustrated in FIG. 9. In FIG. 12, the iTAS apparatus 5 in the first node 2A transmits the first high-priority packet to the iTAS apparatus 5 in the second node 2B when the TS number currently counted is in the range of 10 to 20. The iTAS apparatus 5 in the first node 2A transmits the second high-priority packet to the iTAS apparatus 5 in the second node 2B when the TS number currently counted is in the range of 30 to 35.

The iTAS apparatus 5 in the second node 2B transmits the first high-priority packet to the iTAS apparatus 5 in the fourth node 2D when the TS number currently counted is in the range of 10 to 20. The iTAS apparatus 5 in the second node 2B transmits the second high-priority packet to the iTAS apparatus 5 in the fourth node 2D when the TS number currently counted is in the range of 30 to 35.

The iTAS apparatus 5 in the fourth node 2D transmits the first high-priority packet to the iTAS apparatus 5 in the fifth node 2E when the TS number currently counted is in the range of 10 to 20. The iTAS apparatus 5 in the fourth node 2D transmits the second high-priority packet to the iTAS apparatus 5 in the sixth node 2F when the TS number currently counted is in the range of 30 to 35.

The iTAS apparatus 5 in the fifth node 2E transmits the first high-priority packet to the iTAS apparatus 5 in the seventh node 2G when the TS number currently counted is in the range of 10 to 20. The iTAS apparatus 5 in the sixth node 2F transmits the second high-priority packet to the iTAS apparatus 5 in the seventh node 2G when the TS number currently counted is in the range of 30 to 35.

The iTAS apparatus 5 in the seventh node 2G receives the first high-priority packet when the TS number currently counted is in the range of 10 to 20, and receives the second high-priority packet when the TS number currently counted is in the range of 45 to 50.

Even when the second set path is added to the first set path, the TS numbers used may be synchronized between the iTAS apparatuses 5 in the respective nodes 2 in each of the set paths while taking into account a transmission delay between the paths in the second TS synchronization process. As a result, congestion of high-priority packets may be avoided.

### [Third TS Synchronization Process]

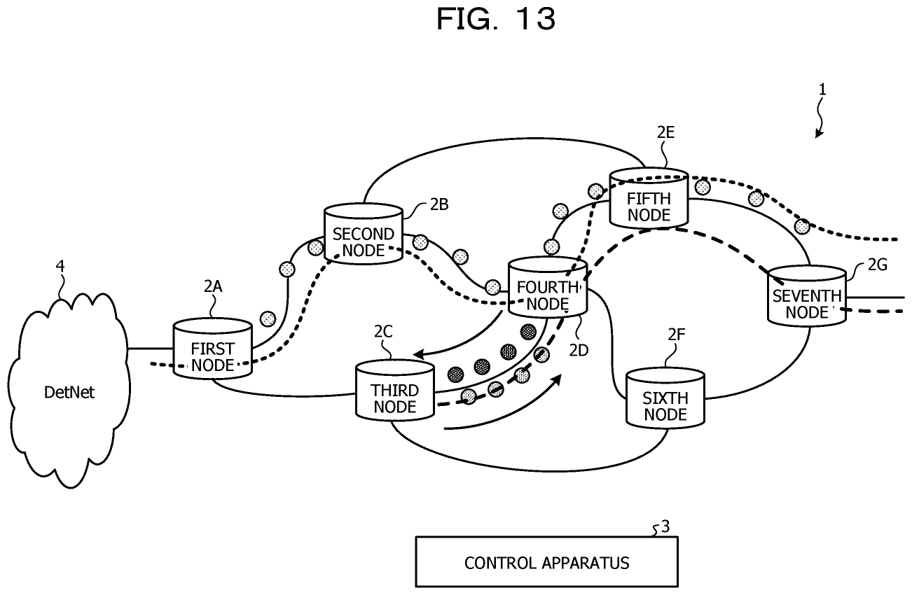

A third TS synchronization process performed when a third set path including a new edge node is added in the first set path will be described next. FIG. 13 is an explanatory diagram illustrating an example of the communication system 1 in a state in which the third set path is added in the first set path. For example, the first set path is a route of the first node 2A→the second node 2B→the fourth node 2D→the fifth node 2E→the seventh node 2G. For example, the third set path is a route of the third node 2C→the fourth node 2D→the fifth node 2E→the seventh node 2G. For example, it is assumed that the edge nodes are the first node 2A in the first set path and the third node 2C in the third set path. The merging node of the first set path and the third set path illustrated in FIG. 13 is, for example, the fourth node 2D where set paths of the different edge nodes pass through a common port.

The control apparatus 3 sets a transfer rule in the iTAS apparatus 5 in each of the nodes 2 in the first set path and the third set path. The fourth node 2D is the merging node of the first set path and the third set path. The transfer rule set in the iTAS apparatus 5 in the fourth node 2D is, for example, a rule of transferring a forward-direction first time packet from the iTAS apparatus 5 in the second node 2B to the iTAS apparatus 5 in the fifth node 2E and to the iTAS apparatus 5 in the third node 2C. The transfer rule of the iTAS apparatus 5 in the fourth node 2D is, for example, a rule of transferring the forward-direction first time packet detouring from the iTAS apparatus 5 in the third node 2C to the iTAS apparatus 5 in the fifth node 2E.

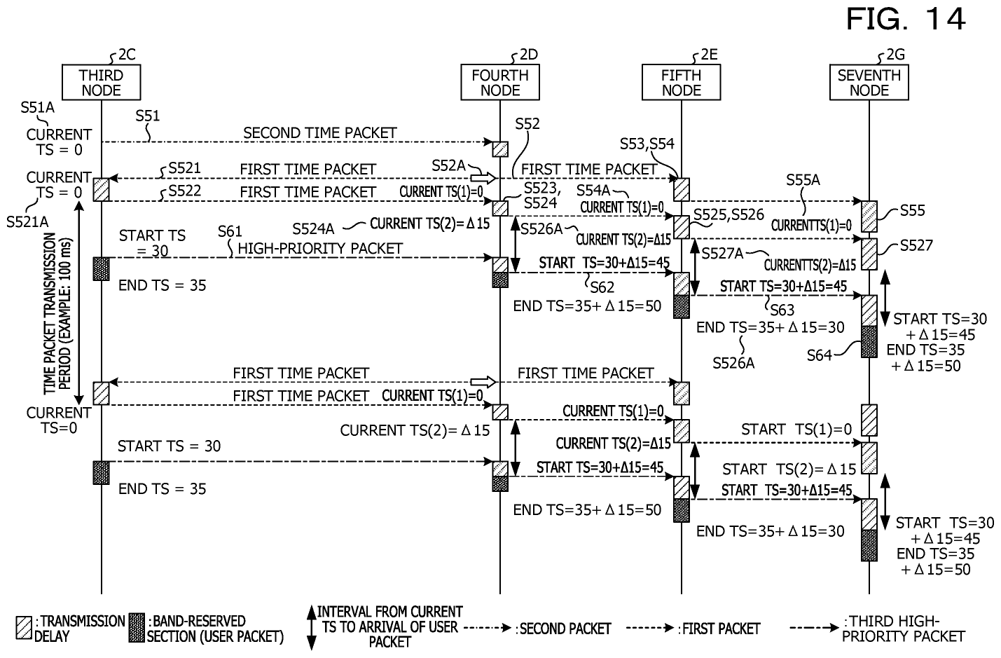

FIG. 14 is a sequence diagram illustrating an example of a processing operation in each of the nodes 2 in the third set path related to the third TS synchronization process. The control apparatus 3 requests the iTAS apparatus 5 in the first node 2A in the first set path to start transmitting a forward-direction first time packet. The control apparatus 3 requests the iTAS apparatus 5 in the third node 2C in the third set path to start transmitting a forward-direction second time packet. In response to the transmission start request, the iTAS apparatus 5 in the first node 2A transmits the forward-direction first time packet to the iTAS apparatus 5 in the second node 2B in the first set path. In response to a start of the transmission of the forward-direction first time packet, the reset unit 24 in the iTAS apparatus 5 in the first node 2A sets the TS number currently counted to 0 and starts the count operation of counting the TS number.

In response to the transmission start request, the iTAS apparatus 5 in the third node 2C also transmits the forward-direction second time packet to the iTAS apparatus 5 in the fourth node 2D in the third set path (operation S51). In response to a start of the transmission of the forward-direction second time packet, the reset unit 24 in the iTAS apparatus 5 in the third node 2C sets the TS number currently counted to 0 (operation S51A). Based on the transfer rule, the iTAS apparatus 5 in the fourth node 2D receives the forward-direction second time packet.

When receiving the forward-direction first time packet from the iTAS apparatus 5 in the second node 2B, the iTAS apparatus 5 in the fourth node 2D transmits this forward-direction first time packet to the iTAS apparatus 5 in the fifth node 2E, based on the transfer rule (operation S52). At the same time, when receiving the forward-direction first time packet from the iTAS apparatus 5 in the second node 2B, the iTAS apparatus 5 in the fourth node 2D transmits the forward-direction first time packet to the iTAS apparatus 5 in the third node 2C, based on the transfer rule (operation S521). The iTAS apparatus 5 in the fourth node 2D sets the TS number currently counted to 0 in response to a start of the transmission of the forward-direction first time packet (operation S52A). The iTAS apparatus 5 in the fourth node 2D notifies the control apparatus 3 of the timing of TS number=0 as a first forward-direction arrival TS.

The iTAS apparatus 5 in the fifth node 2E receives the forward-direction first time packet from the iTAS apparatus 5 in the fourth node 2D (operation S53). The iTAS apparatus 5 in the fifth node 2E transmits the forward-direction first time packet to the iTAS apparatus 5 in the seventh node 2G, based on the transfer rule (operation S54). The iTAS apparatus 5 in the fifth node 2E sets the TS number currently counted to 0 in response to a start of the transmission of the forward-direction first time packet (operation S54A). The iTAS apparatus 5 in the fifth node 2E notifies the control apparatus 3 of the timing of TS number=0 as a first forward-direction arrival TS.

When receiving the forward-direction first time packet from the iTAS apparatus 5 in the fifth node 2E (operation S55), the iTAS apparatus 5 in the seventh node 2G sets the TS number currently counted to 0 (operation S55A). The iTAS apparatus 5 in the seventh node 2G notifies the control apparatus 3 of the timing of TS number=0 as a first forward-direction arrival TS.

The iTAS apparatus 5 in the third node 2C receives the forward-direction first time packet from the iTAS apparatus 5 in the fourth node 2D. The iTAS apparatus 5 in the third node 2C transmits the detouring forward-direction first time packet to the iTAS apparatus 5 in the fourth node 2D, based on the transfer rule (operation S522). The reset unit 24 in the iTAS apparatus 5 in the third node 2C sets the TS number currently counted to 0 in response to a start of the transmission of the forward-direction first time packet (operation S521A). The iTAS apparatus 5 in the third node 2C stops transmission of the second time packet thereafter, and sets the setting of TS number=0 as the transmission timing of the first time packet.

The iTAS apparatus 5 in the fourth node 2D receives the detouring forward-direction first time packet from the iTAS apparatus 5 in the third node 2C (operation S523). When receiving the detouring forward-direction first time packet, the iTAS apparatus 5 in the fourth node 2D transmits the detouring forward-direction first time packet to the iTAS apparatus 5 in the fifth node 2E, based on the transfer rule (operation S524). The iTAS apparatus 5 in the fourth node 2D sets the TS number currently counted as the second forward-direction arrival TS in response to a start of the transmission of the detouring forward-direction first time packet (operation S524A). The iTAS apparatus 5 in the fourth node 2D notifies the control apparatus 3 of the second forward-direction arrival TS. The iTAS apparatus 5 in the fourth node 2D calculates a forward-direction TS difference with (the second forward-direction arrival TS−the first forward-direction arrival TS), and notifies the control apparatus 3 of the calculated forward-direction TS difference.

The iTAS apparatus 5 in the fifth node 2E receives the detouring forward-direction first time packet from the iTAS apparatus 5 in the fourth node 2D (operation S525). When receiving the detouring forward-direction first time packet, the iTAS apparatus 5 in the fifth node 2E transmits the detouring forward-direction first time packet to the iTAS apparatus 5 in the seventh node 2G, based on the transfer rule (operation S526). The iTAS apparatus 5 in the fifth node 2E sets the TS number currently counted as the second forward-direction arrival TS in response to a start of the transmission of the detouring forward-direction first time packet (operation S526A). The iTAS apparatus 5 in the fifth node 2E notifies the control apparatus 3 of the second forward-direction arrival TS. The iTAS apparatus 5 in the fifth node 2E calculates a forward-direction TS difference with (the second forward-direction arrival TS−the first forward-direction arrival TS), and notifies the control apparatus 3 of the calculated forward-direction TS difference.

When receiving the detouring forward-direction first time packet from the iTAS apparatus 5 in the fifth node 2E (operation S527), the iTAS apparatus 5 in the seventh node 2G sets the TS number currently counted as the second forward-direction arrival TS (operation S527A). The iTAS apparatus 5 in the seventh node 2G notifies the control apparatus 3 of the second forward-direction arrival TS. The iTAS apparatus 5 in the seventh node 2G calculates a forward-direction TS difference with (the second forward-direction arrival TS−the first forward-direction arrival TS), and notifies the control apparatus 3 of the calculated forward-direction TS difference.

Based on the forward-direction TS difference and the backward-direction TS difference of each of the nodes 2 in the first set path and the third set path, the control apparatus 3 recognizes an amount of transmission delay between the first set path and the third set path at the iTAS apparatus 5 in each of the fourth node 2D, the fifth node 2E, and the seventh node 2G.

By using the forward-direction TS difference (Δ15) in the iTAS apparatus 5 in the fourth node 2D, the control apparatus 3 corrects the TS range (TS=30 to 35) of the switching information of a third high-priority packet in the GCL. The corrected TS range of the switching information of the third high-priority packet is TS=45 to 50.

By using the forward-direction TS difference (Δ15) in the iTAS apparatus 5 in the fifth node 2E, the control apparatus 3 corrects the TS range (TS=30 to 35) of the switching information of the third high-priority packet in the GCL. The corrected TS range of the switching information of the third high-priority packet is TS=45 to 50.

By using the forward-direction TS difference (Δ15) in the iTAS apparatus 5 in the seventh node 2G, the control apparatus 3 corrects the TS range (TS=30 to 35) of the switching information of the third high-priority packet in the GCL. The corrected TS range of the switching information of the third high-priority packet is TS=45 to 50.

The control apparatus 3 stores, in the node management unit 52A, the forward-direction arrival TS of each of the nodes 2 in the set path, the backward-direction arrival TS of each of the nodes 2 in the set path, the forward-direction TS difference, and the backward-direction TS difference. Based on the forward-direction arrival TS, the backward-direction arrival TS, the forward-direction TS difference, and the backward-direction TS difference in the node management unit 52A, the control apparatus 3 generates the GCL of the edge node in the set path, and sets the generated GCL in the edge node.

The control apparatus 3 corrects the TS range of the start TS and the end TS of each user packet in the GCL, based on the forward-direction arrival TS and the forward-direction TS difference of each of the nodes 2 in the set path. The control apparatus 3 sets the GCL including the corrected TS range in the first node 2A and the third node 2C that are the edge nodes in the forward direction in the respective set paths. The control apparatus 3 corrects the TS range of the start TS and the end TS of each user packet in the GCL, based on the backward-direction arrival TS of each of the nodes 2 in the set path and the backward-direction TS difference. The control apparatus 3 sets the GCL including the corrected TS range in the seventh node 2G that is the edge node in the backward direction in the set path.

For convenience of description, TSs used in the forward-direction set path of the third node 2C→the fourth node 2D→the fifth node 2E→the seventh node 2G are synchronized in the individual nodes 2 in the third set path. Likewise, for the backward-direction set path of the seventh node 2G→the fifth node 2E→the fourth node 2D→the third node 2C, the control apparatus 3 requests the iTAS apparatus 5 in the seventh node 2G to start transmitting a backward-direction time packet. As a result, the individual nodes 2 in the third set path synchronize the TS numbers between the iTAS apparatuses 5 used in the backward direction in the third set path.

The iTAS apparatus 5 in the third node 2C transmits the third high-priority packet to the iTAS apparatus 5 in the fourth node 2D when the TS number currently counted is in the range of 30 to 35 (operation S61). The iTAS apparatus 5 in the fourth node 2D transmits the third high-priority packet to the iTAS apparatus 5 in the fifth node 2E when the TS number currently counted is in a range of 45 to 50 (operation S62). The iTAS apparatus 5 in the fifth node 2E transmits the third high-priority packet to the iTAS apparatus 5 in the seventh node 2G when the TS number currently counted is in the range of 45 to 50 (operation S63). The iTAS apparatus 5 in the seventh node 2G receives the third high-priority packet from the iTAS apparatus 5 in the fifth node 2E when the TS number currently counted is in the range of 45 to 50 (operation S64).

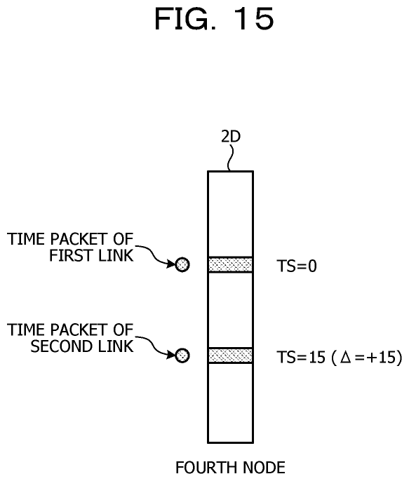

FIG. 15 is an explanatory diagram illustrating an example of the TS difference that occurs in the merging node. In the iTAS apparatus 5 in the fourth node 2D in FIG. 15, the forward-direction TS difference of Δ15 occurs between the first forward-direction arrival TS of a first link and the second forward-direction arrival TS of a second link. The first link corresponds to a link from the second node 2B to the fourth node 2D, and the second link corresponds to a link from the third node 2C to the fourth node 2D. The forward-direction TS difference is an amount of transmission delay between the first link and the second link.

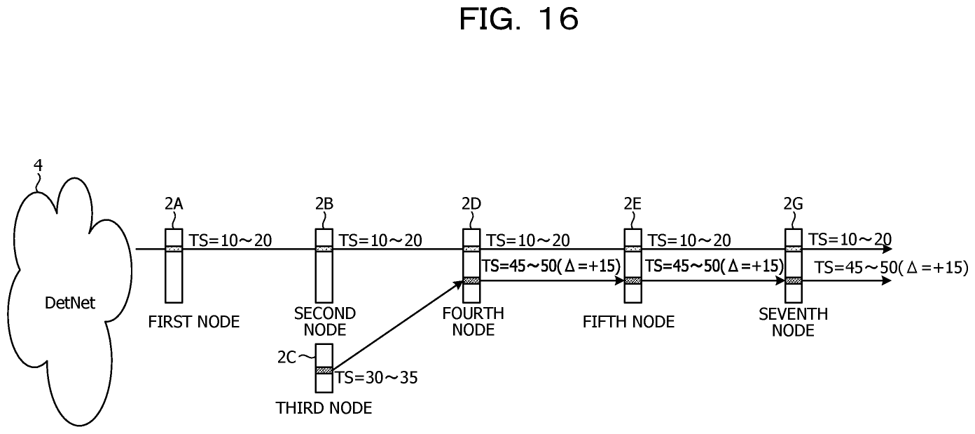

FIG. 16 is an explanatory diagram illustrating an example of the TS ranges of the first high-priority packet and the third high-priority packet in each of the nodes 2 illustrated in FIG. 13. In FIG. 16, the iTAS apparatus 5 in the first node 2A transmits the first high-priority packet to the iTAS apparatus 5 in the second node 2B when the TS number currently counted is in the range of 10 to 20. The iTAS apparatus 5 in the second node 2B transmits the first high-priority packet to the iTAS apparatus 5 in the fourth node 2D when the TS number currently counted is in the range of 10 to 20.

The iTAS apparatus 5 in the third node 2C transmits the third high-priority packet to the iTAS apparatus 5 in the fourth node 2D when the TS number currently counted is 30 to 35.

The iTAS apparatus 5 in the fourth node 2D transmits the first high-priority packet to the iTAS apparatus 5 in the fifth node 2E when the TS number currently counted is in the range of 10 to 20. The iTAS apparatus 5 in the fourth node 2D transmits the third high-priority packet to the iTAS apparatus 5 in the fifth node 2E when the TS number currently counted is in the range of 45 to 50.

The iTAS apparatus 5 in the fifth node 2E transmits the first high-priority packet to the iTAS apparatus 5 in the seventh node 2G when the TS number currently counted is in the range of 10 to 20. The iTAS apparatus 5 in the fifth node 2E transmits the third high-priority packet to the iTAS apparatus 5 in the seventh node 2G when the TS number currently counted is 45 to 50.

The iTAS apparatus 5 in the seventh node 2G receives the first high-priority packet when the TS number currently counted is in the range of 10 to 20, and receives the third high-priority packet when the TS number currently counted is in the range of 45 to 50.

Even when the third set path is added to the first set path such that packets from the plurality of edge nodes pass through the merging node, the TS numbers used are synchronized between the iTAS apparatuses 5 in the respective nodes 2 in the set paths while a transmission delay between the paths is taken into account in the third TS synchronization process. As a result, congestion of high-priority packets may be avoided.

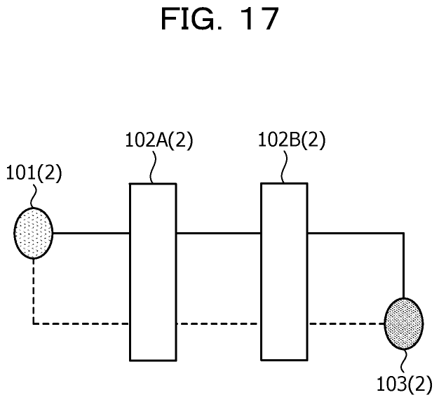

FIG. 17 is a schematic diagram of the communication system 1 in a state in which the first set path is set. The set path illustrated in FIG. 17 includes a source node 101, two intermediate nodes 102 (102A and 102B), and a destination node 103. The destination node 103 is a node serving as a destination. The set path includes a forward-direction path of the source node 101→the intermediate node 102A→the intermediate node 102B→the destination node 103 and a backward-direction path of the destination node 103→the intermediate node 102B→the intermediate node 102A→the source node 101.

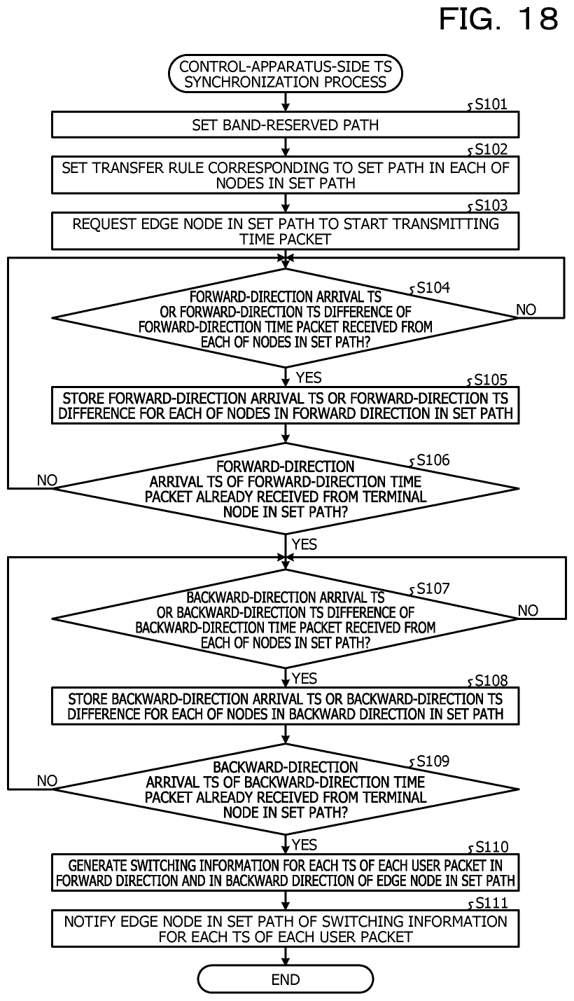

FIG. 18 is a flowchart illustrating an example of a processing operation of the control apparatus 3 related to a control-apparatus-side TS synchronization process. The control apparatus 3 sets a band-reserved path (operation S101). After setting the band-reserved path, the control apparatus 3 sets a transfer rule corresponding to the set path in each of the nodes 2 in the set path (operation S102). Each of the nodes 2 in the set path corresponds to the source node 101, the intermediate node 102, or the destination node 103 in the set path illustrated in FIG. 17.

The control apparatus 3 requests the edge node in the set path to start transmitting a time packet (operation S103). The edge node corresponds to the source node 101 in the case of the set path illustrated in FIG. 17. The control apparatus 3 determines whether the forward-direction arrival TS or the forward-direction TS difference of the forward-direction time packet are received from each of the nodes 2 in the set path (operation S104). If the forward-direction arrival TS or the forward-direction TS difference of the forward-direction time packet are received (operation S104: Yes), the control apparatus 3 stores the forward-direction arrival TS or the forward-direction TS difference for each of the nodes 2 in the node management unit 52A in the storage unit 52 (operation S105). The control apparatus 3 determines whether the forward-direction arrival TS of the forward-direction time packet is already received from the terminal node in the set path (operation S106).

If the forward-direction arrival TS of the forward-direction time packet is already received (operation S106: Yes), the control apparatus 3 determines that the forward-direction time packet has passed through all the nodes 2 in the set path. The control apparatus 3 determines whether the backward-direction arrival TS or the backward-direction TS difference of the backward-direction time packet are received from each of the nodes 2 in the set path (operation S107).

If the backward-direction arrival TS or the backward-direction TS difference of the backward-direction time packet are received (operation S107: Yes), the control apparatus 3 stores the backward-direction arrival TS or the backward-direction TS difference for each of the nodes 2 in the node management unit 52A in the storage unit 52 (operation S108). The control apparatus 3 determines whether the backward-direction arrival TS of the backward-direction time packet is already received from the terminal node in the set path (operation S109).

If the backward-direction arrival TS is already received (operation S109: Yes), the control apparatus 3 determines that the backward-direction time packet has passed through all the nodes 2 in the set path. The control apparatus 3 generates switching information for each TS of each user packet in the forward direction and in the backward direction of the edge node in the set path (operation S110). For example, based on the forward-direction arrival TS, the forward-direction TS difference, the backward-direction arrival TS, or the backward-direction TS difference, the control apparatus 3 generates the switching information for each TS of each user packet in the forward direction and in the backward direction of the edge node in the set path. The edge node in the set path in the forward direction corresponds to the source node 101 in the case of the set path illustrated in FIG. 17, and the edge node in the set path in the backward direction corresponds to the destination node 103 in the case of the set path illustrated in FIG. 17.

After generating the switching information for each TS of each user packet in the forward direction and in the backward direction of the edge node, the control apparatus 3 notifies the edge node in the set path of the switching information for each TS of each user packet (operation S111), and ends the processing operation illustrated in FIG. 18. As a result, the edge node in the set path receives the switching information for each TS of each user packet, and sets the received switching information for each TS in the GCL 23. As a result, by using the forward-direction arrival TS, the backward-direction arrival TS, the forward-direction TS difference, and the backward-direction TS difference of each of the nodes 2 in the set path, the edge node synchronizes the TS numbers between the iTAS apparatuses 5 in the respective nodes 2 in the set path while taking into account the transmission delay.

If the control apparatus 3 does not receive the forward-direction arrival TS and the forward-direction TS difference of the forward-direction time packet (operation S104: No), the process returns to the processing of operation S104. If the control apparatus 3 has not received the forward-direction arrival TS of the forward-direction time packet from the terminal node in the set path (operation S106: No), the process returns to the processing of operation S104.

If the control apparatus 3 does not receive the backward-direction arrival TS and the backward-direction TS difference of the backward-direction time packet (operation S107: No), the process returns to the processing of operation S107. If the control apparatus 3 has not received the backward-direction arrival TS of the backward-direction time packet from the terminal node in the set path (operation S109: No), the process returns to the processing of operation S107.

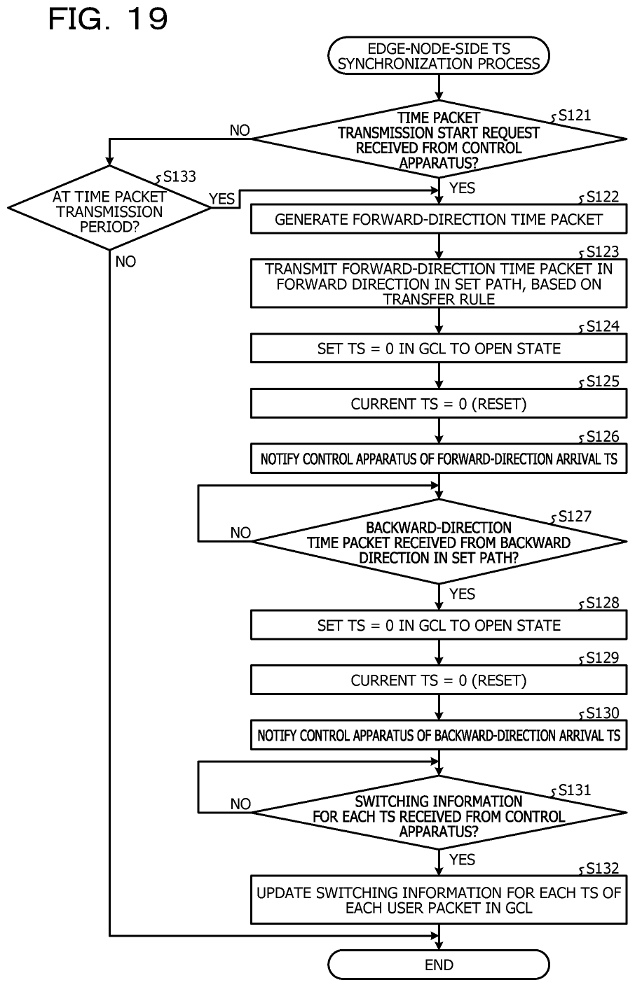

FIG. 19 is a flowchart illustrating an example of a processing operation of the edge node related to an edge-node-side TS synchronization process. The edge node corresponds to the source node 101 in the case of the set path illustrated in FIG. 17. In FIG. 19, the iTAS apparatus 5 in the edge node determines whether a time packet transmission start request is received from the control apparatus 3 (operation S121). If the time packet transmission start request is received from the control apparatus 3 (operation S121: Yes), the iTAS apparatus 5 in the edge node generates a forward-direction time packet (operation S122). The iTAS apparatus 5 in the edge node transmits the forward-direction time packet to the node 2 that is adjacent in the forward direction in the set path, based on the transfer rule (operation S123). The node 2 that is adjacent in the forward direction in the set path corresponds to, for example, the intermediate node 102 in the case of the set path illustrated in FIG. 17.

The iTAS apparatus 5 in the edge node sets TS number=0 in the GCL 23 to the open state (operation S124), and sets the TS number currently counted to 0 (operation S125). The iTAS apparatus 5 in the edge node notifies the control apparatus 3 of the timing of TS number=0 as a forward-direction arrival TS (operation S126). As a result, based on the forward-direction arrival TS related to the time packet of the edge node in the set path, the control apparatus 3 may recognize the switching information for each TS used in communication of the edge node in the forward direction.

The iTAS apparatus 5 in the edge node determines whether a backward-direction time packet is received from the backward direction in the set path (operation S127). If the backward-direction time packet is received from the backward direction in the set path (operation S127: Yes), the iTAS apparatus 5 in the edge node sets TS number=0 in the GCL 23 to the open state (operation S128). The iTAS apparatus 5 in the edge node sets the current TS number currently counted to 0 (operation S129). The iTAS apparatus 5 in the edge node notifies the control apparatus 3 of the timing of TS number=0 as a backward-direction arrival TS (operation S130). As a result, based on the backward-direction arrival TS related to the time packet of the edge node in the set path, the control apparatus 3 may recognize the switching information for each TS used in communication of the edge node in the backward direction.

The iTAS apparatus 5 in the edge node determines whether the switching information for each TS is received from the control apparatus 3 (operation S131). If the switching information for each TS is received from the control apparatus 3 (operation S131: Yes), the iTAS apparatus 5 in the edge node updates the switching information for each TS of each user packet in the GCL 23 (operation S132), and ends the processing operation illustrated in FIG. 19.

If the time packet transmission start request is not received from the control apparatus 3 (operation S121: No), the iTAS apparatus 5 in the edge node determines whether the current timing is at the transmission period of the time packet (operation S133). If the current timing is at the transmission period of the time packet (operation S133: Yes), the process proceeds to operation S122 so that the iTAS apparatus 5 in the edge node generates the forward-direction time packet. If the current timing is not at the transmission period of the time packet (operation S133: No), the iTAS apparatus 5 in the edge node ends the processing operation illustrated in FIG. 19.

If the iTAS apparatus 5 in the edge node does not receive the backward-direction time packet from the backward direction in the set path (operation S127: No), the process returns to the processing of operation S127. If the iTAS apparatus 5 in the edge node does not receive the switching information for each TS from the control apparatus 3 (operation S131: No), the process returns to the processing of operation S131.

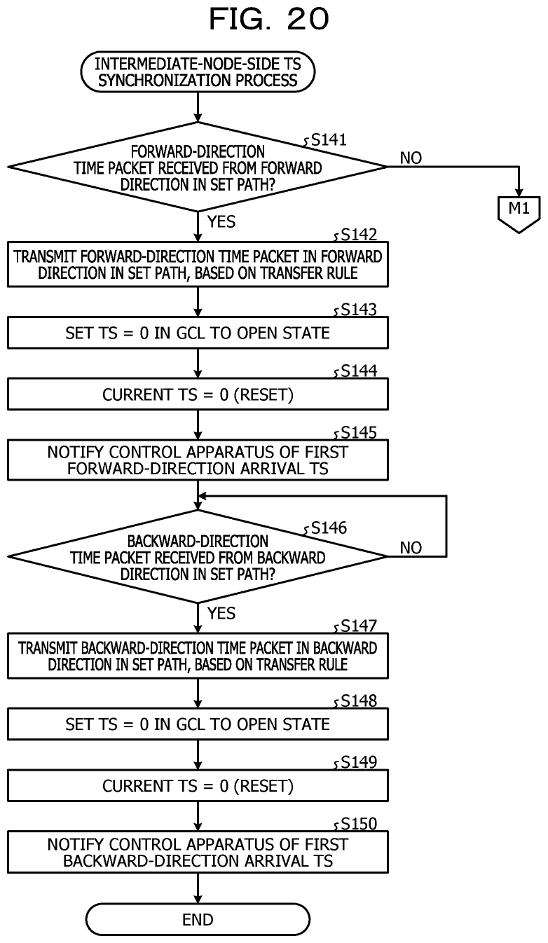

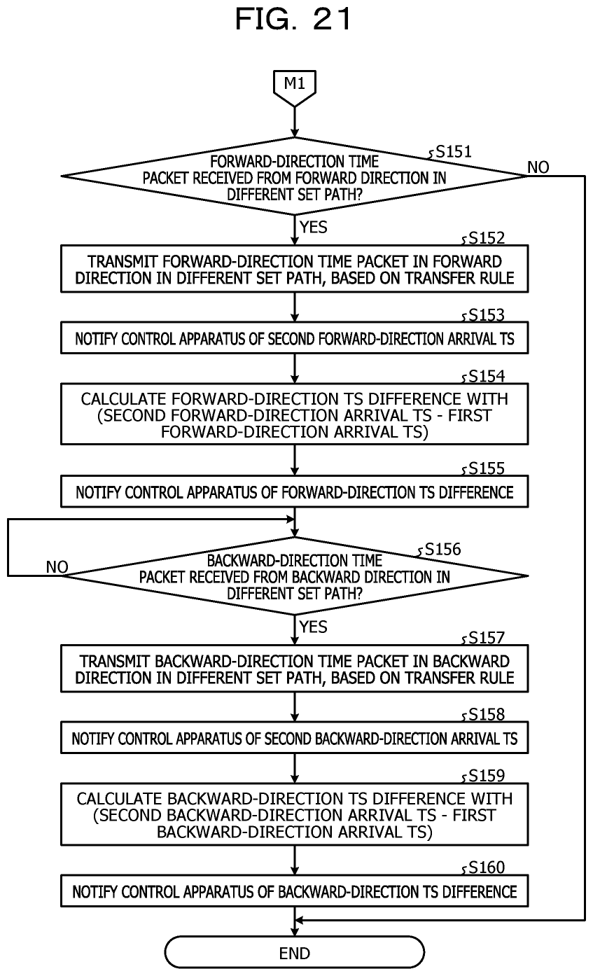

FIGS. 20 and 21 are flowcharts illustrating an example of a processing operation of the intermediate node related to an intermediate-node-side TS synchronization process. The iTAS apparatus 5 in the intermediate node determines whether a forward-direction time packet is received from the forward direction in the set path (operation S141). If the forward-direction time packet is received from the forward direction in the set path (operation S141: Yes), the iTAS apparatus 5 in the intermediate node transmits the forward-direction time packet to the node 2 that is adjacent in the forward direction in the set path, based on the transfer rule (operation S142).

The iTAS apparatus 5 in the intermediate node sets TS number=0 in the GCL to the open state (operation S143), and sets the TS number currently counted to 0 (operation S144). The iTAS apparatus 5 in the intermediate node notifies the control apparatus 3 of the timing of TS number=0 as a first forward-direction arrival TS (operation S145). As a result, based on the forward-direction arrival TS related to the time packet of the intermediate node in the set path, the control apparatus 3 may recognize the switching information for each TS used in communication of the intermediate node in the forward direction.

The iTAS apparatus 5 in the intermediate node determines whether a backward-direction time packet is received from the backward direction in the set path (operation S146). If the backward-direction time packet is received from the backward direction in the set path (operation S146: Yes), the iTAS apparatus 5 in the intermediate node transmits the backward-direction time packet to the node 2 that is adjacent in the backward direction in the set path, based on the transfer rule (operation S147).

The iTAS apparatus 5 in the intermediate node sets TS number=0 in the GCL 23 to the open state (operation S148), and sets the TS number currently counted to 0 (operation S149). The iTAS apparatus 5 in the intermediate node notifies the control apparatus 3 of the timing of TS number=0 as a first backward-direction arrival TS (operation S150). As a result, based on the backward-direction arrival TS related to the time packet of the intermediate node in the set path, the control apparatus 3 may recognize the switching information for each TS used in communication of the intermediate node in the backward direction.

If the iTAS apparatus 5 in the intermediate node does not receive the forward-direction time packet from the forward direction in the set path (operation S141: No), the process proceeds to M1 illustrated in FIG. 21. If the iTAS apparatus 5 in the intermediate node does not receive the backward-direction time packet from the backward direction in the set path (operation S146: No), the process returns to the processing of operation S146.

At M1 illustrated in FIG. 21, the iTAS apparatus 5 in the intermediate node determines whether the forward-direction time packet is received from the forward direction of a different set path (operation S151). The different set path corresponds to, for example, the second set path when the set path is the first set path.

If the forward-direction time packet is received from the forward direction of the different set path (operation S151: Yes), the iTAS apparatus 5 in the intermediate node transmits the forward-direction time packet to the node 2 that is adjacent in the forward direction in the set path, based on the transfer rule (operation S152). The iTAS apparatus 5 in the intermediate node notifies the control apparatus 3 of the TS number currently counted as a second forward-direction arrival TS (operation S153). The iTAS apparatus 5 in the intermediate node calculates a forward-direction TS difference with (the second forward-direction arrival TS−the first forward-direction arrival TS) (operation S154), and notifies the control apparatus 3 of the forward-direction TS difference (operation S155). As a result, based on the first forward-direction arrival TS and the second forward-direction arrival TS related to the time packet of the intermediate node, the control apparatus 3 may recognize the switching information for each TS used in communication of the intermediate node in the forward direction while taking into account the transmission delay between the paths.

The iTAS apparatus 5 in the intermediate node determines whether the backward-direction time packet is received from the backward direction in a different set path (operation S156). If the backward-direction time packet is received from the backward direction in the different set path (operation S156: Yes), the iTAS apparatus 5 in the intermediate node transmits the backward-direction time packet to the node 2 that is adjacent in the backward direction in the different set path, based on the transfer rule (operation S157). The iTAS apparatus 5 in the intermediate node notifies the control apparatus 3 of the TS number currently counted as a second backward-direction arrival TS (operation S158).

The iTAS apparatus 5 in the intermediate node calculates a backward-direction TS difference with (the second backward-direction arrival TS−the first backward-direction arrival TS) (operation S159), and notifies the control apparatus 3 of the backward-direction TS difference (operation S160). As a result, based on the first backward-direction arrival TS and the second backward-direction arrival TS related to the time packet of the intermediate node, the control apparatus 3 may recognize the switching information for each TS used in communication of the intermediate node in the backward direction while taking into account the transmission delay between the paths.

If the iTAS apparatus 5 in the intermediate node does not receive the forward-direction time packet from the forward direction in the different set path (operation S151: No), the processing operation illustrated in FIG. 21 ends. If the iTAS apparatus 5 in the intermediate node does not receive the backward-direction time packet from the backward direction in the different set path (operation S156: No), the process returns to the processing of operation S156.

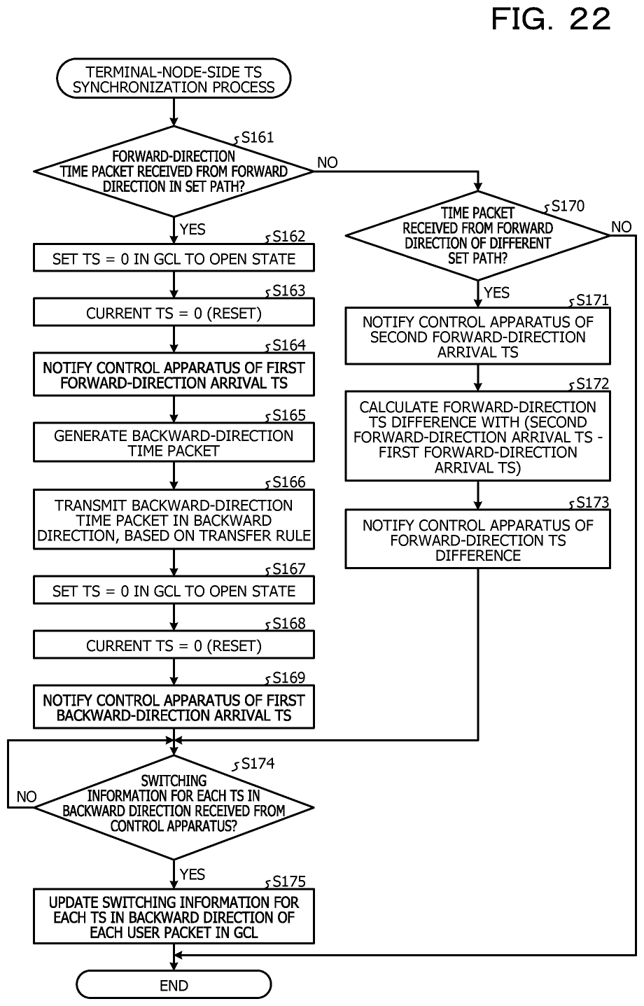

FIG. 22 is a flowchart illustrating an example of a processing operation of the terminal node related to a terminal-node-side TS synchronization process. The terminal node corresponds to the destination node 103 in the case of the set path illustrated in FIG. 17. The iTAS apparatus 5 in the terminal node determines whether a forward-direction time packet is received from the forward direction in the set path (operation S161). If the forward-direction time packet is received from the forward direction in the set path (operation S161: Yes), the iTAS apparatus 5 in the terminal node sets TS=0 in the GCL 23 to the open state (operation S162). The iTAS apparatus 5 in the terminal node sets the TS number currently counted to 0 (operation S163). The iTAS apparatus 5 in the terminal node notifies the control apparatus 3 of the timing of TS number=0 as a first forward-direction arrival TS (operation S164). As a result, based on the first forward-direction arrival TS related to the time packet of the terminal node in the set path, the control apparatus 3 may recognize the switching information for each TS used in communication of the terminal node in the forward direction.

The iTAS apparatus 5 in the terminal node generates a backward-direction time packet (operation S165), and transmits the backward-direction time packet to the node 2 that is adjacent in the backward direction in the set path, based on the transfer rule (operation S166). The iTAS apparatus 5 in the terminal node sets TS number=0 in the GCL 23 to the open state (operation S167), and sets the TS number currently counted to 0 (operation S168). The iTAS apparatus 5 in the terminal node notifies the control apparatus 3 of the timing of TS number=0 as a first backward-direction arrival TS (operation S169). As a result, based on the first backward-direction arrival TS related to the time packet of the terminal node in the set path, the control apparatus 3 may recognize the switching information for each TS used in communication of the terminal node in the backward direction.

If the forward-direction time packet is not received from the forward direction in the set path (operation S161: No), the iTAS apparatus 5 in the terminal node determines whether a time packet is received from the forward direction of a different set path (operation S170).

If a time packet is received from the forward direction of the different set path (operation S170: Yes), the iTAS apparatus 5 in the terminal node notifies the control apparatus 3 of the TS number currently counted as a second forward-direction arrival TS (operation S171). The iTAS apparatus 5 in the terminal node calculates a forward-direction TS difference with (the second forward-direction arrival TS−the first forward-direction arrival TS) (operation S172), and notifies the control apparatus 3 of the forward-direction TS difference (operation S173). As a result, based on the first forward-direction arrival TS and the second forward-direction arrival TS related to the time packet of the terminal node, the control apparatus 3 may recognize the switching information for each TS used in communication of the terminal node in the forward direction while taking into account the transmission delay between the paths.

After the iTAS apparatus 5 in the terminal node notifies the control apparatus 3 of the first backward-direction arrival TS in operation S169 or notifies the control apparatus 3 of the forward-direction TS difference in operation S173, the iTAS apparatus 5 in the terminal node determines whether the switching information for each TS in the backward direction is received from the control apparatus 3 (operation S174). If the switching information for each TS in the backward direction is received (operation S174: Yes), the iTAS apparatus 5 in the terminal node updates the switching information for each TS in the backward direction in the GCL 23 (operation S175), and ends the processing operation illustrated in FIG. 22.

If the time packet is not received from the forward direction of the different set path (operation S170: No), the iTAS apparatus 5 in the terminal node ends the processing operation illustrated in FIG. 22. If the iTAS apparatus 5 in the terminal node does not receive the switching information for each TS in the backward direction (operation S174: No), the process returns to the processing of operation S174.

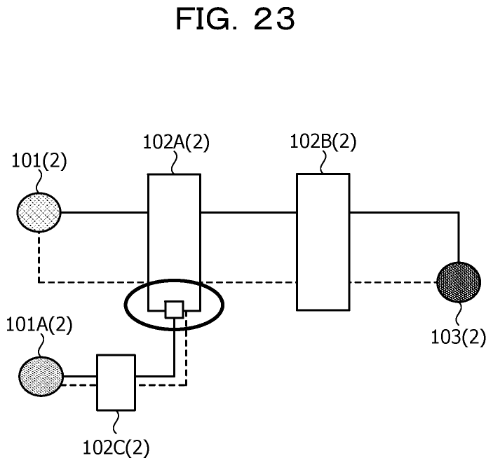

FIG. 23 is a schematic diagram of the communication system 1 in a state in which a fourth set path is added to the first set path. The intermediate node 102A in the first set path illustrated in FIG. 23 is added in the fourth set path. The fourth set path is a route that includes a new source node 101A and a new intermediate node 102C coupled to the source node 101A and couples the intermediate node 102C and the intermediate node 102A to each other. The intermediate node 102A is a merging node where the first set path and the fourth set path merge together.

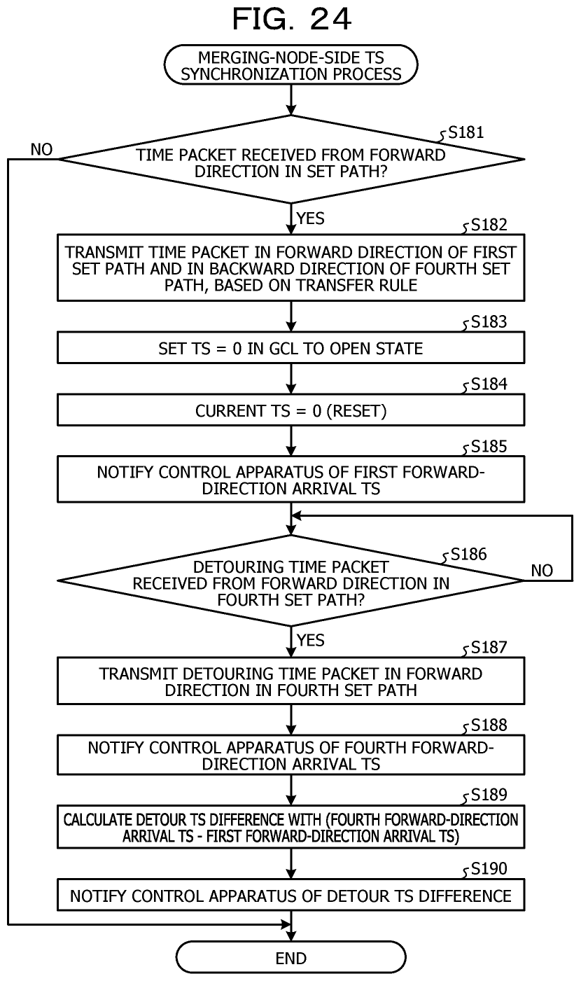

FIG. 24 is a flowchart illustrating an example of a processing operation of the merging node related to a merging-node-side TS synchronization process. The iTAS apparatus 5 in the merging node determines whether a forward-direction time packet is received from the forward direction in the set path (operation S181). If the forward-direction time packet is received (operation S181: Yes), the iTAS apparatus 5 in the merging node transmits the forward-direction time packet to the node 2 (the intermediate node 102B) that is adjacent in the forward direction in the first set path, based on the transfer rule. At the same time, if the forward-direction time packet is received (operation S181: Yes), the iTAS apparatus 5 in the merging node transmits the forward-direction time packet to the node 2 (the intermediate node 102C) that is adjacent in the backward direction in the fourth set path (operation S182).

The iTAS apparatus 5 in the merging node sets TS=0 in the GCL 23 to the open state (operation S183), and sets the TS number currently counted to 0 (operation S184). The iTAS apparatus 5 in the merging node notifies the control apparatus 3 of the timing of TS number=0 as a first forward-direction arrival TS (operation S185). As a result, based on the forward-direction arrival TS related to the time packet of the merging node in the set path, the control apparatus 3 may recognize the switching information for each TS used in communication of the merging node in the forward direction.

The iTAS apparatus 5 in the merging node determines whether a detouring time packet is received from the forward direction in the fourth set path (operation S186). If the detouring time packet is received from the forward direction in the fourth set path (operation S186: Yes), the iTAS apparatus 5 in the merging node transmits the detouring time packet to the node 2 that is adjacent in the forward direction in the fourth set path, based on the transfer rule (operation S187).

The iTAS apparatus 5 in the merging node notifies the control apparatus 3 of the TS number currently counted as a fourth forward-direction arrival TS (operation S188). The iTAS apparatus 5 in the merging node calculates a forward-direction detour TS difference with (the fourth forward-direction arrival TS−the first forward-direction arrival TS) (operation S189), notifies the control apparatus 3 of the forward-direction detour TS difference (operation S190), and ends the processing operation illustrated in FIG. 24. As a result, based on the forward-direction arrival TS related to the time packet of the merging node in the set path and the forward-direction detour TS difference, the control apparatus 3 may recognize the switching information for each TS used in communication of the merging node in the forward direction.

If the iTAS apparatus 5 in the merging node does not receive the forward-direction time packet (operation S181: No), the processing operation illustrated in FIG. 24 ends. If the iTAS apparatus 5 in the merging node does not receive the detouring time packet from the forward direction in the fourth set path (operation S186: No), the process returns to the processing of operation S186.

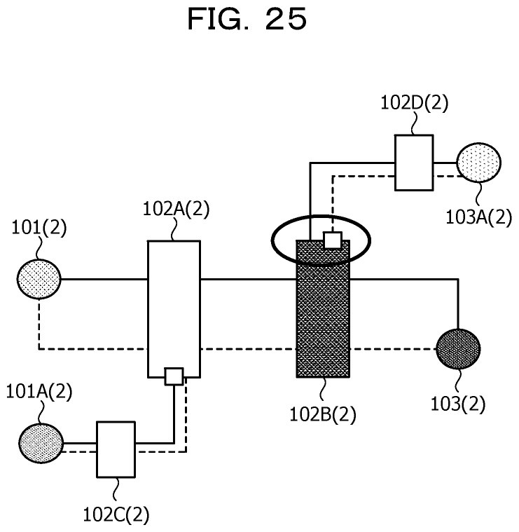

FIG. 25 is a schematic diagram of the communication system 1 in a state in which a fifth set path is added to the first set path. The intermediate node 102B in the first set path illustrated in FIG. 25 is added in the fifth set path. The fifth set path is a route that includes a new destination node 103A and a new intermediate node 102D coupled to the destination node 103A and couples the intermediate node 102B and the intermediate node 102D to each other. The intermediate node 102B is a merging node where the first set path and the fifth set path merge together.

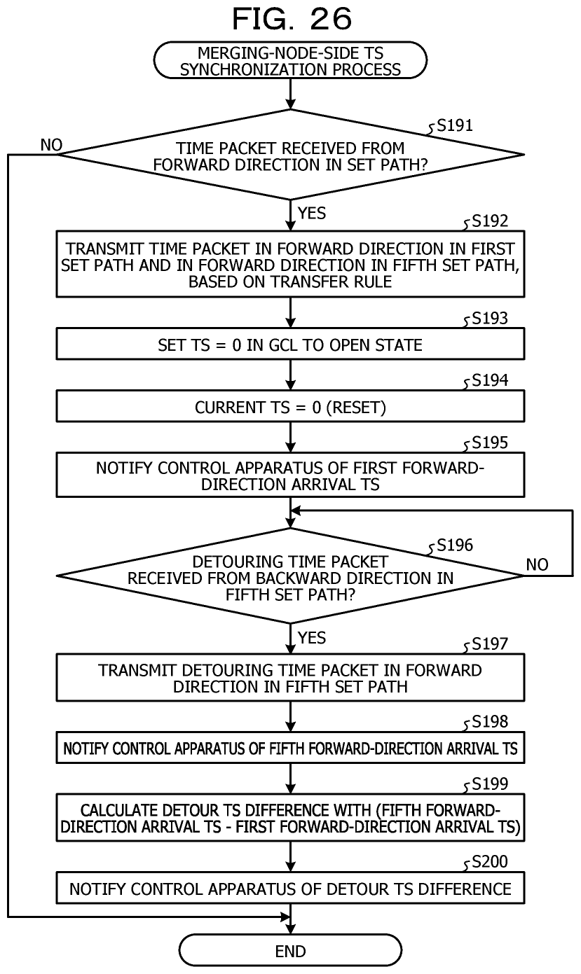

FIG. 26 is a flowchart illustrating an example of a processing operation of the merging node related to the merging-node-side TS synchronization process. The merging node corresponds to the intermediate node 102B in the case of the set path illustrated in FIG. 25. The iTAS apparatus 5 in the merging node determines whether a forward-direction time packet is received from the forward direction in the set path (operation S191). If a forward-direction time packet is received (operation S191: Yes), the iTAS apparatus 5 in the merging node transmits the forward-direction time packet to the node 2 (the destination node 103) that is adjacent in the forward direction in the first set path, based on the transfer rule. Likewise, if the forward-direction time packet is received (operation S191: Yes), the iTAS apparatus 5 in the merging node transmits the forward-direction time packet to the node 2 (the intermediate node 102D) that is adjacent in the forward direction in the fifth set path (operation S192).

The iTAS apparatus 5 in the merging node sets TS=0 in the GCL 23 to the open state (operation S193), and sets the TS number currently counted to 0 (operation S194). The iTAS apparatus 5 in the merging node notifies the control apparatus 3 of the timing of TS number=0 as a first forward-direction arrival TS (operation S195). As a result, based on the forward-direction arrival TS related to the time packet of the merging node in the set path, the control apparatus 3 may recognize the switching information for each TS used in communication of the merging node in the forward direction.

The iTAS apparatus 5 in the merging node determines whether a detouring time packet is received from the backward direction in the fifth set path (operation S196). If a detouring time packet is received from the backward direction in the fifth set path (operation S196: Yes), the iTAS apparatus 5 in the merging node transmits the detouring time packet to the node 2 that is adjacent in the forward direction in the first set path, based on the transfer rule (operation S197).

The iTAS apparatus 5 in the merging node notifies the control apparatus 3 of the TS number currently counted as a fifth forward-direction arrival TS (operation S198). The iTAS apparatus 5 in the merging node calculates a forward-direction detour TS difference with (the fifth forward-direction arrival TS−the first forward-direction arrival TS) (operation S199), notifies the control apparatus 3 of the forward-direction detour TS difference (operation S200), and ends the processing operation illustrated in FIG. 26. As a result, based on the forward-direction arrival TS related to the time packet of the merging node in the set path and the forward-direction detour TS difference, the control apparatus 3 may recognize the switching information for each TS used in communication of the merging node in the forward direction.

If the iTAS apparatus 5 in the merging node does not receive the forward-direction time packet (operation S191: No), the processing operation illustrated in FIG. 26 ends. If the iTAS apparatus 5 in the merging node does not receive the detouring time packet from the backward direction in the fifth set path (operation S196: No), the process returns to the processing of operation S196.

The edge node in the set path according to the present embodiment transmits a time packet for resetting a TS number currently counted in each iTAS apparatus 5 in the set path, in the forward direction of the set path in accordance with a predetermined timing. In response to a start of the transmission of the time packet, the edge node resets the TS number currently counted and restarts a count operation of the counter. As a result, each node in the set path may avoid congestion of high-priority packets by synchronizing the TS numbers between the iTAS apparatuses 5.

The edge node notifies the control apparatus 3 of an arrival TS that is timing information on a timing of the resetting of the TS number currently counted. As a result, the control apparatus 3 may recognize the timing of the resetting of the TS number used in the edge node.

In response to receipt of the time packet from the forward direction of the set path, the intermediate node in the set path transmits this time packet in the forward direction of the set path. In response to a start of the transmission of the time packet, the intermediate node resets the TS number currently counted and restarts the count operation of the counter. As a result, each node in the set path may avoid congestion of high-priority packets by synchronizing the TS numbers between the iTAS apparatuses 5.

The intermediate node notifies the control apparatus 3 of an arrival TS that is timing information on a timing of the resetting of the TS number currently counted. As a result, the control apparatus 3 may recognize the timing of the resetting of the TS number used in the intermediate node.

In response to receipt of a time packet from another set path different from the set path after the restart of the count operation of counting the TS number, the intermediate node notifies the control apparatus 3 of the TS number currently counted as a TS difference between the set path and the another set path. As a result, the control apparatus 3 may avoid congestion of high-priority packets by synchronizing the TS numbers between the iTAS apparatuses 5 while taking into account a transmission delay between the set path and the another set path based on the arrival TS and the TS difference of each iTAS apparatus 5 in the set path and the another set path.

In response to receipt of the time packet from the forward direction in the set path, the intermediate node transmits this time packet in the forward direction of the set path and transmits the time packet in the backward direction of the another set path. In response to receipt of the returning time packet from the forward direction in the another set path, the intermediate node notifies the control apparatus 3 of the TS number currently counted as the TS difference between the set path and the another set path. As a result, the control apparatus 3 may avoid congestion of high-priority packets by synchronizing the TS numbers between the iTAS apparatuses 5 while taking into account a transmission delay between the set path and the another set path based on the arrival TS and the TS difference of each iTAS apparatus 5 in the set path and the another set path.

In response to receipt of the time packet addressed thereto from the forward direction in the set path, the terminal node in the set path resets the TS number currently counted and restarts the count operation of the counter. As a result, each node in the set path may avoid congestion of high-priority packets by synchronizing the TS numbers between the iTAS apparatuses 5.

The terminal node notifies the control apparatus 3 of an arrival TS that is timing information on a timing of the resetting of the TS number currently counted. As a result, the control apparatus 3 may recognize the timing of the resetting of the TS number used in the terminal node.

In response to receipt of a time packet from another set path different from the set path after the restart of the count operation of counting the TS number, the terminal node notifies the control apparatus 3 of the TS number currently counted as a TS difference between the set path and the another set path. As a result, the control apparatus 3 may avoid congestion of high-priority packets by synchronizing the TS numbers between the iTAS apparatuses 5 while taking into account a transmission delay between the set path and the another set path based on the arrival TS and the TS difference of each iTAS apparatus 5 in the set path and the another set path.

The edge node in the set path transmits the time packet in the forward direction of the set path in accordance with a predetermined timing, and in response to a start of the transmission of the time packet, resets the TS number currently counted and starts the count operation. In response to receipt of the time packet that flows through the set path in the forward direction, the intermediate node in the set path transmits the time packet in the forward direction of the set path, and in response to a start of the transmission of the time packet, resets the TS number currently counted and starts the count operation. In response to receipt of the time packet that flows through the set path in the forward direction, the terminal node in the set path resets the TS number currently counted and starts the count operation. As a result, each node in the set path may avoid congestion of high-priority packets by synchronizing the TS numbers between the iTAS apparatuses 5.

The edge node notifies the control apparatus 3 of an arrival TS of the timing of the resetting of the TS number currently counted. The intermediate node notifies the control apparatus 3 of an arrival TS of the timing of the resetting of the TS number currently counted. The terminal node notifies the control apparatus 3 of an arrival TS of the timing of the resetting of the TS number currently counted. Based on the arrival TS of each of the nodes, the control apparatus corrects the switching information for each TS number in the edge node, and notifies the edge node of the corrected switching information. The edge node preferentially outputs high-priority packets, based on the corrected switching information, so that the intermediate node and the terminal node in the set path correct the switching information for each TS number, based on periodicity of the high-priority packets from the edge node. As a result, each node in the set path may avoid congestion of high-priority packets by synchronizing the TS numbers between the iTAS apparatuses 5.

The communication system 1 enables band reservation of an ultra-low delay logical path in a DetNet/TAS. By setting the TS number in each of the nodes 2 in the set path to 0 in accordance with the time packet controlled by the iTAS apparatus 5, the TS numbers are synchronized between the iTAS apparatuses 5 of the respective nodes 2 in the set path while taking into account the transmission delay between the set paths.

In the communication system 1, the control apparatus 3 selects an appropriate TS and instructs the edge node to transmit a user packet in the set path in which TSs are synchronized, so that congestion of high-priority packets may be avoided in each node in the set path.

As an alternative to the present embodiment, TS synchronization using Precision Time Protocol (PTP) is also conceivable. However, since only time is determined in the PTP, Ethernet Delay Measurement (Eth-DM) or a Two-Way Active Measurement Protocol (TWAMP) for TS synchronization and measurement of a transmission delay of each link is to be used separately. In the alternative, the control apparatus is to perform TS allocation setting directly on all nodes in the set path. By contrast, in the control apparatus 3 according to the present embodiment, since the band reservation (setting of the TS) to be used by each of the nodes 2 in the set path is performed only for the edge node, the coupling normality with all the nodes 2 does not have to be assured and it is sufficient to assure the coupling normality with the edge node.

Although it is assumed in the above embodiment that there are two types of packets which are an MFH packet that is a high-priority packets and an MBH packet that is a low-priority packet, the packets are not limited to these two types and may be changed as appropriate.

For convenience of description, the case is exemplified where the control unit 30 in the iTAS apparatus 5 in each of the nodes 2 in the set path calculates the TS difference based on the arrival TS of the set path and the arrival TS of the different set path, and notifies the control apparatus 3 of the calculated TS difference. However, in a case where the control apparatus 3 receives the arrival TS of the set path and the arrival TS of the different set path from each of the iTAS apparatuses 5, the control apparatus 3 may calculate the TS difference based on these arrival TSs. Thus, the configuration may be changed as appropriate.

The edge node notifies the control apparatus 3 of the arrival TS of the timing of the resetting of the TS number currently counted. The intermediate node notifies the control apparatus 3 of an arrival TS of the timing of the resetting of the TS number currently counted. The terminal node notifies the control apparatus 3 of an arrival TS of the timing of the resetting of the TS number currently counted. Based on the arrival TS of each of the nodes, the control apparatus corrects the switching information for each TS number in the edge node, and notifies the edge node of the corrected switching information. The edge node preferentially outputs high-priority packets, based on the corrected switching information, so that the intermediate node and the terminal node in the set path correct the switching information for each TS number, based on periodicity of the high-priority packets from the edge node. However, the edge node, the intermediate node, and the terminal node may skip notifying the control apparatus 3 of the arrival TS of the timing of the resetting of the TS number currently counted. The edge node, the intermediate node, and the terminal node each correct the switching information for each TS number therein, based on the arrival TS of the timing of the resetting of the TS number currently counted, and set the corrected switching information. By preferentially outputting high-priority packets based on the corrected switching information, the edge node, the intermediate node, and the terminal node correct the switching information for each TS number based on the periodicity of the high-priority packets. As a result, each node in the set path may avoid congestion of high-priority packets by synchronizing the TS numbers between the iTAS apparatuses 5.

The elements of the respective units illustrated in the drawings do not necessarily have to be physically configured as illustrated. For example, specific configurations of dispersion and integration of the respective units are not limited to those illustrated in the drawings, and all or some of the elements may be configured in a functionally or physically dispersed and integrated manner in an arbitrary unit depending on various loads, usage, and the like.

As for the various processing functions executed in each apparatus, all or an arbitrary part thereof may be executed by a central processing unit (CPU) (or a microcomputer such as a microprocessor unit (MPU) or a microcontroller unit (MCU)). It goes without saying that, all or an arbitrary part of the various processing functions may be executed by a program to be analyzed and executed by the CPU (or microcomputer such as the MPU or MCU) or by wired logic hardware.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A packet processing apparatus comprising:
a memory configured to store, for each time slot number, switching information for switching output of a packet of each packet type;
a counter configured to count the time slot number;
an output control circuit configured to control the output, based on the switching information that corresponds to the time slot number currently counted;
a transmitter configured to transmit a control packet for resetting the time slot number currently counted in each packet processing apparatus in a set path, in a predetermined direction of the set path in accordance with a predetermined timing; and
a reset circuit configured to, in response to a start of a transmission of the control packet, reset the time slot number currently counted and restart a count operation of the counter.

2. The packet processing apparatus according to claim 1, further comprising:
a control circuit configured to notify a control apparatus that controls each packet processing apparatus in the set path of timing information on a timing of the resetting of the time slot number currently counted.

3. A packet processing apparatus comprising:
a memory configured to store, for each time slot number, switching information for switching output of a packet of each packet type;
a counter configured to count the time slot number;
an output control circuit configured to control the output, based on the switching information that corresponds to the time slot number currently counted;
a receiver configured to receive a control packet from a first direction on a set path; and
a reset circuit configured to, based on the received control packet, reset the time slot number currently counted and restart a count operation of the counter.

4. The packet processing apparatus according to claim 3, further comprising:
a transmitter configured to, in response to receipt of the control packet from the first direction of the set path, transmit the control packet in the first direction of the set path,
wherein the reset circuit is configured to reset the time slot number currently counted and restart the count operation of the counter.

5. The packet processing apparatus according to claim 4, further comprising:
a control circuit configured to notify a control apparatus that controls each packet processing apparatus in the set path of timing information on a timing of the resetting of the time slot number currently counted.

6. The packet processing apparatus according to claim 5,
wherein the control circuit is configured to, in response to receipt of the control packet from another set path different from the set path after the restart of the count operation of counting the time slot number, notify the control apparatus of the time slot number currently counted as a difference between the set path and the another set path.

7. The packet processing apparatus according to claim 6,
wherein the transmitter is configured to, in response to receipt of the control packet from the first direction of the set path, transmit the control packet in the first direction of the set path and transmit the control packet in a second direction of the another set path, the second direction being reverse to the first direction, and
wherein the control circuit is configured to, in response to receipt of the control packet returned to the second direction of the another set path from the first direction, notify the control apparatus of the time slot number currently counted as the difference between the set path and the another set path.

8. The packet processing apparatus according to claim 3,
wherein the reset circuit is configured to, in response to receipt of the control packet addressed to the packet processing apparatus from the first direction in the set path, reset the time slot number currently counted and restart the count operation of the counter.

9. The packet processing apparatus according to claim 8, further comprising:
a control circuit configured to notify a control apparatus that controls the packet processing apparatus in the set path of timing information on a timing of the resetting of the time slot number currently counted.

10. The packet processing apparatus according to claim 9,
wherein the control circuit is configured to, in response to receipt of the control packet from another set path different from the set path after the restart of the count operation of counting the time slot number, notify the control apparatus of the time slot number currently counted as a difference between the set path and the another set path.

11. A communication system comprising:
a first packet processing apparatus configured to serve as a start point of a set path;
a second packet processing apparatus configured to serve as an end point of the set path;
a third packet processing apparatus arranged between the first packet processing apparatus and the second packet processing apparatus in the set path; and
a control apparatus configured to control the first packet processing apparatus, the second packet processing apparatus, and the third packet processing apparatus,
wherein the first packet processing apparatus is configured to transmit a control packet in a predetermined direction of the set path in accordance with a predetermined timing, and in response to a start of the transmission of the control packet, reset a time slot number currently counted and start a count operation,
wherein the third packet processing apparatus is configured to, in response to receipt of the control packet that flows through the set path in the predetermined direction, transmit the control packet in the predetermined direction of the set path, reset the time slot number currently counted, and start the count operation, and
wherein the second packet processing apparatus is configured to, in response to receipt of the control packet that flows through the set path in the predetermined direction, reset the time slot number currently counted and start the count operation.

12. The communication system according to claim 11,
wherein the first packet processing apparatus is configured to notify the control apparatus of first timing information on a timing of the resetting of the time slot number currently counted,
wherein the second packet processing apparatus is configured to notify the control apparatus of second timing information on a timing of the resetting of the time slot number currently counted,
wherein the third packet processing apparatus is configured to notify the control apparatus of third timing information on a timing of the resetting of the time slot number currently counted, and
wherein the control apparatus is configured to
correct, for each time slot number in the first packet processing apparatus, switching information for switching output of a packet of each packet type, based on the first timing information, the second timing information, and the third timing information, and
notify the first packet processing apparatus of the corrected switching information.
